(19) United States
(12) Patent Application Publication
(10) Pub. No.: US 2026/0194632 A1
(43) Pub. Date: Jul. 9, 2026

(54) LIGHTING DEVICE AND RANGING DEVICE

(71) Applicant: SONY SEMICONDUCTOR SOLUTIONS CORPORATION, KANAGAWA (JP)

(72) Inventors: TAKASHI KOBAYASHI, KANAGAWA (JP); MIDORI KANAYA, KANAGAWA (JP)

(21) Appl. No.: 19/134,726

(22) PCT Filed: Oct. 24, 2023
(86) PCT No.: PCT/JP2023/038238

§ 371 Date: May 31, 2025

(30) Foreign Application Priority Data
Dec. 6, 2022 (JP) 2022-194925

(51) Int. Cl. G01S 7/481; G02B 1/00; G02B 3/00; G02B 5/02; G02B 5/18; G02B 27/30

(52) U.S. Cl. CPC G01S 7/4815; G02B 1/002; G02B 3/005; G02B 5/0278; G02B 5/18; G02B 27/30; G02B 2005/1804

(57) ABSTRACT

For example, provided is a lighting device that irradiates an irradiation target with light with as few gaps as possible.

The lighting device includes a light-emitting element including a plurality of light-emitting units arranged in an array, a first optical member arranged near the light-emitting element, the first optical member being arranged in an emission direction of light beams emitted from the light-emitting units to reduce a gap between the light beams emitted from the light-emitting units adjacent to each other and make the light beams uniform in light intensity, and a second optical member that roughly collimates divergent light from the first optical member.

### TECHNICAL FIELD

The present disclosure relates to a lighting device and a ranging device.

### BACKGROUND ART

Development is underway on lighting devices that are used for applications such as distance measurement and object shape recognition based on time of flight (ToF) and are applied to laser imaging detection and ranging (LiDAR) systems essential for automated driving systems for automobiles. In Patent Document 1 below, a surface-emitting semiconductor laser is described as the light source for such a lighting device.

### CITATION LIST

### Patent Document

Patent Document 1: Japanese Patent Application Laid-Open No. 2011-61083

### SUMMARY OF THE INVENTION

### Problems to be Solved by the Invention

In such a field, it is desirable that a target object be irradiated with light beams emitted from a lighting device with as few gaps as possible.

It is therefore an object of the present disclosure to provide a lighting device capable of irradiating a target object with light beams with as few gaps as possible, and a ranging device including the lighting device.

### Solutions to Problems

The present disclosure is, for example, a lighting device including:
a light-emitting element including a plurality of light-emitting units arranged in an array;
a first optical member arranged near the light-emitting element, the first optical member being arranged in an emission direction of light beams emitted from the light-emitting units to reduce a gap between the light beams emitted from the light-emitting units adjacent to each other and make the light beams uniform in light intensity; and
a second optical member that roughly collimates divergent light from the first optical member.

The present disclosure is, for example, a lighting device including:
a light-emitting element including a plurality of light-emitting units arranged in an array; and
an optical functional member provided near the light-emitting element, the optical functional member being configured to make a light-emitting area larger for each of the light-emitting units and make a non-irradiation area between the light-emitting units smaller.

The present disclosure may be a ranging device including the above-described lighting device.

### BRIEF DESCRIPTION OF DRAWINGS

FIG. 1 is a diagram referred to in describing the problems to be considered in the present disclosure.

FIG. 2 is a diagram referred to in describing the problems to be considered in the present disclosure.

FIG. 3 is a diagram referred to in describing the problems to be considered in the present disclosure.

FIG. 4 is a diagram referred to in describing the problems to be considered in the present disclosure.

FIG. 5 is a diagram for describing a configuration example of a ranging device according to embodiments.

FIG. 6 is a diagram for describing a configuration example of a light-emitting unit according to the embodiments.

FIG. 7 is a diagram for describing a configuration example of a drive circuit of the light-emitting unit according to the embodiments.

FIGS. 8A and 8B are diagrams for describing the configuration example of the drive circuit of the light-emitting unit according to the embodiments.

FIG. 9 is a diagram referred to in describing a configuration example of a lighting device according to a first embodiment.

FIG. 10 is a diagram referred to in describing the configuration example of the lighting device according to the first embodiment.

FIG. 11 is a diagram to be referred to in describing an example of effects achieved by the lighting device according to the first embodiment.

FIG. 12 is a diagram to be referred to in describing a modification of the first embodiment.

FIG. 13 is a diagram to be referred to in describing a modification of the first embodiment.

FIG. 14 is a diagram to be referred to in describing a modification of the first embodiment.

FIG. 15 is a diagram referred to in describing a configuration example of a lighting device according to a second embodiment.

FIG. 16 is a diagram referred to in describing the configuration example of the lighting device according to the second embodiment.

FIG. 17 is a diagram to be referred to in describing a modification of the second embodiment.

FIG. 18 is a diagram referred to in describing a configuration example of a lighting device according to a third embodiment.

FIG. 19 is a diagram referred to in describing an example of effects of the lighting device according to the third embodiment.

FIG. 20 is a diagram referred to in describing another example of the effects of the lighting device according to the third embodiment.

FIG. 21 is a diagram referred to in describing a modification of the lighting device according to the third embodiment.

FIG. 22 is a diagram referred to in describing a modification of the lighting device according to the third embodiment.

FIG. 23 is a diagram referred to in describing a configuration example of a lighting device according to a fourth embodiment.

FIG. 24 is a diagram illustrating an example of a freeform lens.

FIG. 25 is a diagram referred to in describing a modification of the lighting device according to the fourth embodiment.

FIG. 26 is a diagram referred to in describing a modification of the lighting device according to the fourth embodiment.

FIG. 27 is a diagram referred to in describing a configuration example of a lighting device according to a fifth embodiment.

FIG. 28 is a diagram referred to in describing a modification of the lighting device according to the fifth embodiment.

FIG. 29 is a diagram referred to in describing a modification of the lighting device according to the fifth embodiment.

FIG. 30 is a diagram referred to in describing a configuration example of a lighting device according to a sixth embodiment.

FIG. 31 is a diagram referred to in describing a modification of the lighting device according to the sixth embodiment.

FIG. 32 is a diagram referred to in describing a modification of the lighting device according to the sixth embodiment.

FIG. 33 is a diagram referred to in describing a modification of the lighting device according to the sixth embodiment.

FIG. 34 is a block diagram illustrating an example of a schematic configuration of a vehicle control system.

FIG. 35 is an explanatory diagram illustrating an example of installation positions of an outside-vehicle information detecting section and an imaging section.

### MODE FOR CARRYING OUT THE INVENTION

Hereinafter, embodiments and the like of the present disclosure will be described below with reference to the drawings. Note that the description will be given in the following order.
<Problems to be Considered in the Present Disclosure>
<Common Configurations Across Embodiments>
<First embodiment>
<Second embodiment>
<Third embodiment>
<Fourth embodiment>
<Fifth embodiment>
<Sixth embodiment>
<Modifications>
<Application examples>

Note that the embodiments and the like to be described below are preferred specific examples of the present disclosure, and the content of the present disclosure is not limited to the embodiments and the like. Note that, in the following description, components having substantially the same functional configuration are denoted by the same reference numeral, and redundant description will be omitted as appropriate. Furthermore, in order to prevent the illustration from being complicated, only some of the components may be denoted by reference numerals, or may be simplified or scaled up/down in their illustrations.

### PROBLEMS TO BE CONSIDERED IN THE PRESENT DISCLOSURE

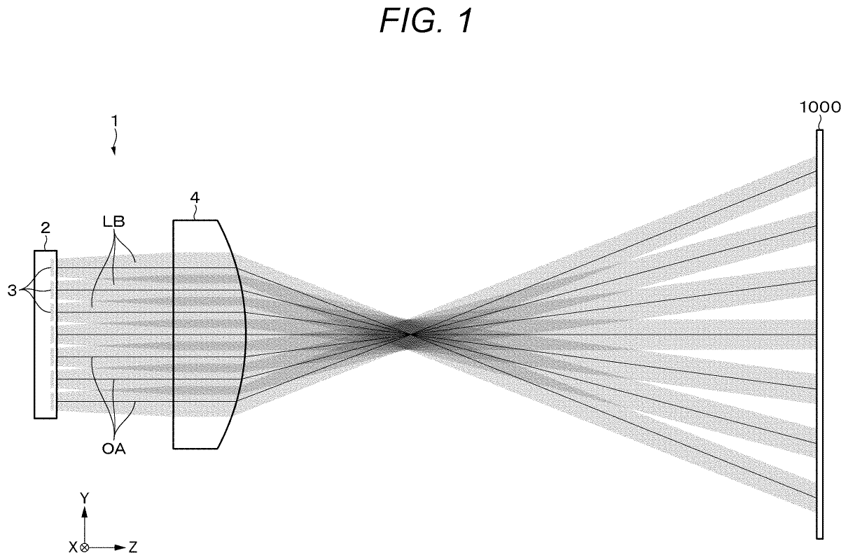

First, to facilitate understanding of the present disclosure, problems to be considered in the present disclosure will be described with reference to FIGS. 1 to 4. FIG. 1 is a diagram illustrating a configuration example of a general lighting device (lighting device 1). The lighting device 1 includes, for example, a light-emitting element 2 including a plurality of light-emitting units 3, and a collimator lens 4 arranged in the propagation direction of light beams LB emitted from the light-emitting units 3. Note that, in FIG. 1, the light beams LB are indicated by gray, and dark-colored areas indicate where a plurality of light beams LB overlap. The darker the color of the light beams LB, the greater the degree of overlap, that is, the greater the light intensity. Furthermore, a line OA extending in the emission direction from approximately the center of each light-emitting unit 3 indicates the optical axis of the light beam LB. This also applies to the drawings other than FIG. 1.

The light beams LB emitted from the light-emitting units 3 are each roughly collimated by the collimator lens 4 and are then converged. After being converged, each light beam LB is applied to an irradiation target 1000.

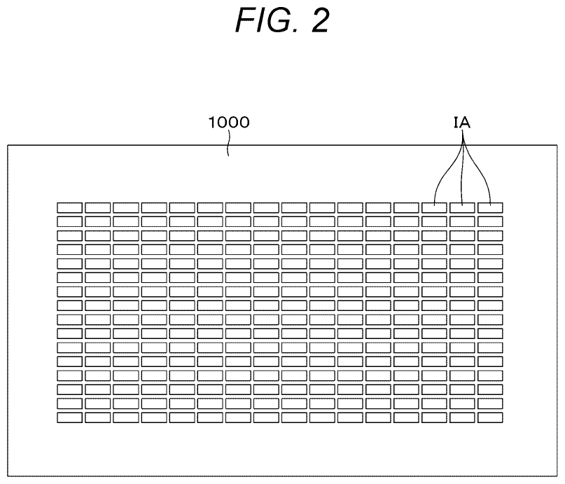

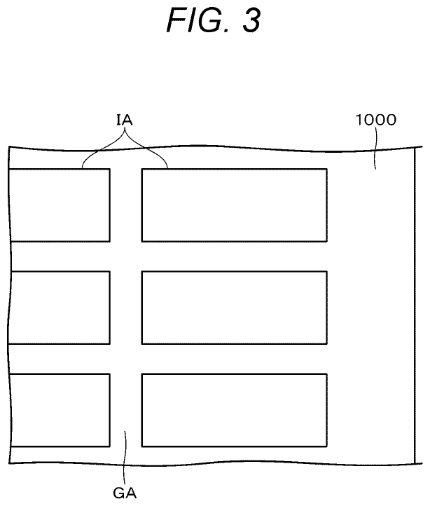

FIG. 2 is a diagram schematically illustrating how the light beam LB emitted from each light-emitting unit 3 is applied to the irradiation target 1000. FIG. 3 is an enlarged view of a part of FIG. 2. As illustrated in FIG. 3, there is a gap GA indicating an area not irradiated with the light beams LB between irradiation areas IA corresponding to the light-beams LB. In a case where the lighting device 1 is used as a ranging device, such a gap GA may deteriorate the accuracy of distance measurement.

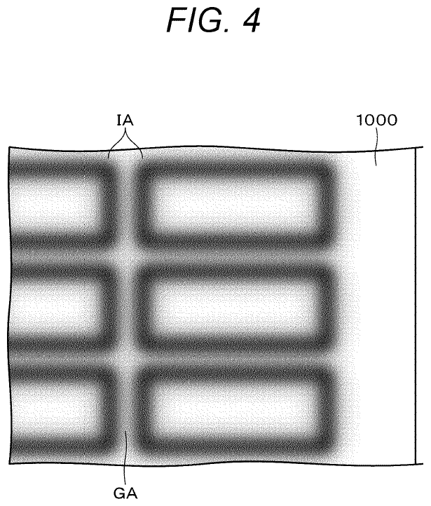

Therefore, a countermeasure to reduce the gap GA by defocusing the light beams LB and irradiating the irradiation target 1000 with the defocused light beams LB can be considered. Here, being defocused refers to, for example, a state where, with an angle of a non-irradiation area (for example, an angle viewed from the direction illustrated in FIG. 1) denoted as 40, a divergence angle Aw of the light beams (irradiation beams) from the collimator lens exceeds Δθ/2. As illustrated in FIG. 4, even in a case where the light beams LB are defocused, the gap GA is formed between the irradiation areas IA, that is, it is not possible to uniformly irradiate the gap GA with light.

Furthermore, when the irradiation target 1000 is uniformly irradiated (irradiated with as few gaps GA as possible) with the defocused light beams LB, the spreading of light outside the light-irradiation area becomes larger, deteriorating light utilization efficiency. Then, a high light output is required to prevent the deterioration of light utilization efficiency, which may cause an increase in size, cost, and power consumption of the lighting device, and cause an increase in strain on the reliability of the lighting device. Furthermore, there is a possibility that a reduction in the light intensity in the light-irradiation area will lead to a decrease in the measurement range. Moreover, there is a possibility that a reduction in a uniformity of the light intensity in the light-irradiation area will cause the measurement range to vary within the light-irradiation area. Taking the above points into consideration, the present disclosure will be described in detail with reference to the embodiments.

### COMMON CONFIGURATIONS ACROSS EMBODIMENTS

Before describing each embodiment, common configurations across the embodiments will be described.

### CONFIGURATION EXAMPLE OF RANGING DEVICE

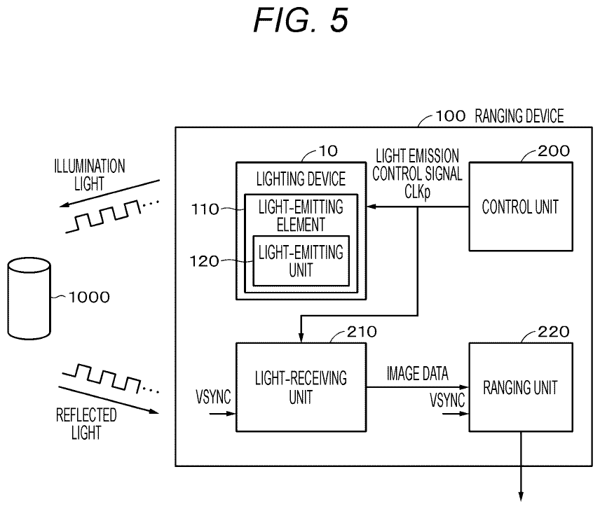

FIG. 5 is a block diagram illustrating a configuration example of a ranging device (ranging device 100) to which a lighting device (lighting device 10) according to the embodiments can be applied. The ranging device 100 is configured to measure a distance to the irradiation target 1000 (ranging distance) by irradiating the irradiation target 1000 with illumination light and receiving light reflected off the irradiation target 1000. The ranging device 100 employs, for example, a time of flight (ToF) method or a structured light method. The ToF method is a method of calculating a distance from the time until the light beams emitted from the ranging device are reflected off the irradiation target and returned to the ranging device. The structured light method is a method of irradiating the irradiation target with a pattern of the light beams emitted from the ranging device and calculating a distance from distortion of the pattern of the light beams reflected and returned to the ranging device.

The ranging device 100 includes the lighting device 10, a control unit 200 that controls the lighting device 10, a light-receiving unit 210, and a ranging unit 220. The lighting device 10 generates irradiation light in synchronization with a light emission control signal CLKp of a rectangular wave issued from the control unit 200. The light emission control signal CLKp is only required to be a periodic signal, and is not limited to the rectangular wave. For example, the light emission control signal CLKp may be a sine wave.

The lighting device 10 includes a light-emitting element 110. Furthermore, the light-emitting element 110 includes a plurality of light-emitting units 120. Although details will be described later, the plurality of light-emitting units 120 is arranged in an array on a first main surface of a substrate of the light-emitting element 110, for example.

The light-receiving unit 210 receives light reflected off the irradiation target 1000 and detects, each time the period of a vertical synchronization signal VSYNC elapses, the amount of light received within the period. In the light-receiving unit 210, a plurality of pixel circuits is arranged in a two-dimensional lattice pattern, for example. The light-receiving unit 210 supplies image data (frame) corresponding to the amount of light received by these pixel circuits to the ranging unit 220. Note that, the light-receiving unit 210 has a function of correcting a ranging error caused by multipath, for example.

The control unit 200 controls the lighting device 10 and the light-receiving unit 210. The control unit 200 generates the light emission control signal CLKp and supplies the same to the lighting device 10 and the light-receiving unit 210.

The ranging unit 220 measures a distance to the irradiation target 1000 by the ToF method or the like on the basis of the image data. The ranging unit 220 measures the distance for each pixel circuit and generates a depth map indicating, for each pixel, a distance to an object using grayscale values. This depth map is used in, for example, image processing of performing blurring processing according to the distance, autofocus (AF) processing of obtaining a focal point of a focus lens according to the distance, distance measurement to the target object using automotive LiDAR, and the like. Needless to say, the use of the lighting device according to the present disclosure is not limited to the above-described applications.

### CONFIGURATION EXAMPLE OF LIGHT-EMITTING UNIT

Next, a configuration example of the light-emitting unit 120 will be described. The light-emitting unit 120 according to the embodiments is, for example, a surface-emitting laser, more specifically, a vertical-cavity surface-emitting laser (hereinafter, also referred to as VCSEL where appropriate).

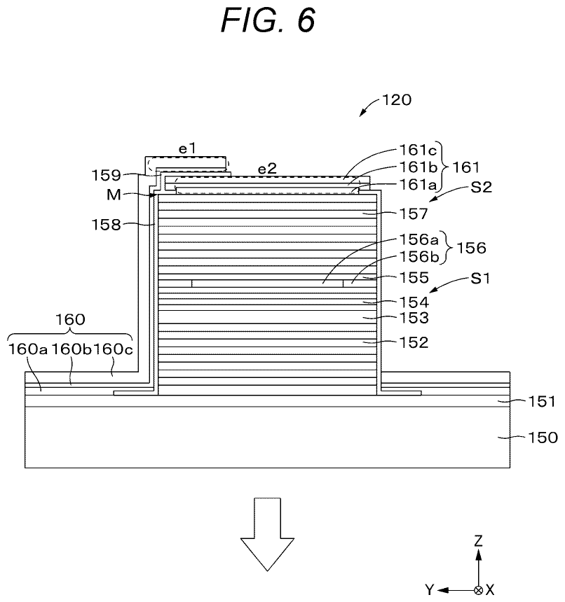

As illustrated in FIG. 6, the light-emitting unit 120 includes a first structure S1 including a first multilayer film reflector 152, a second structure S2 including a second multilayer film reflector 157, an active layer 154 arranged between the first and second structures S1 and S2, a first electrode e1 electrically connected to the first structure S1, and a second electrode e2 electrically connected to the second structure S2. The light-emitting unit 120 is driven by, for example, a driver (not illustrated).

The first structure S1 further includes a substrate 150 arranged on a side of the first multilayer film reflector 152 remote from the active layer 154, a contact layer 151 arranged between the substrate 150 and the first multilayer film reflector 152, and a first cladding layer 153 arranged between the first multilayer film reflector 152 and the active layer 154.

The second structure S2 further includes a second cladding layer 155 arranged between the second multilayer film reflector 157 and the active layer 154. An oxide confinement layer 156 is provided in the second cladding layer 155.

The first and second structures S1 and S2 and the active layer 154 constitute a resonator.

A part of the first structure S1, the second structure S2, and the active layer 154 constitute a mesa M with a top in the second structure S2. The mesa M constitutes at least a part of the light-emitting unit. The mesa M includes, as an example, the first multilayer film reflector 152, the first cladding layer 153, the active layer 154, the second cladding layer 155 including the oxide confinement layer 156, and the second multilayer film reflector 157. The mesa M has, for example, a polygonal prism shape, but may have another shape such as an approximately cylindrical shape, an approximately elliptical cylindrical shape, a polygonal prism shape, a truncated cone shape, an elliptical frustum shape, or a polygonal frustum shape. A height direction of the mesa M approximately coincides with a stacking direction (vertical direction) of the light-emitting unit 120. The mesa M has a diameter of, for example, 1 μm to 500 μm.

As an example, the light-emitting unit 120 emits laser light from the back surface (bottom surface) of the substrate 150. That is, the light-emitting unit 120 is, as an example, a bottom-emitting VCSEL. Needless to say, the light-emitting unit 120 according to the embodiments may be a top-emitting VCSEL.

### Substrate

The substrate 150 includes, as an example, a semiconductor substrate (for example, a GaAs substrate) of a first conductivity type (for example, n-type) . On the back surface (bottom surface) of the substrate 150, a thin film that does not absorb or absorbs very little of the light emitted from the light-emitting unit 120 (light with an oscillation wavelength A emitted from the light-emitting unit 120) is formed as an AR coating film.

### Contact Layer

The contact layer 151 includes, as an example, a semiconductor layer (for example, a GaAs layer) of the first conductivity type (for example, n-type). The contact layer 151 has higher impurity doping concentration and lower resistance than the substrate 150.

### First Multilayer Film Reflector

The first multilayer film reflector 152 is, as an example, a semiconductor multilayer film reflector. The multilayer film reflector is also referred to as a distributed Bragg reflector. The semiconductor multilayer film reflector which is a type of multilayer film reflector (distributed Bragg reflector) has low light absorption, high reflectance, and conductivity. More specifically, the first multilayer film reflector 152 is, as an example, a semiconductor multilayer film reflector of the first conductivity type (for example, n-type), and has a structure in which a plurality of types (for example, two types) of semiconductor layers different in refractive index from each other are alternately stacked with an optical thickness equal to a quarter of the oscillation wavelength. Each refractive index layer of the first multilayer film reflector 152 includes an AlGaAs-based compound semiconductor of the first conductivity type (for example, n-type). The first multilayer film reflector 152 is set slightly higher in reflectance than the second multilayer film reflector 157.

### First Cladding Layer

The first cladding layer 153 includes, as an example, an AlGaAs-based compound semiconductor of the first conductivity type (for example, n-type).

### Active Layer

The active layer 154 has, as an example, a quantum well structure including a barrier layer including an AlGaAs-based compound semiconductor and a quantum well layer. This quantum well structure may be a single quantum well structure (QW structure) or a multiple quantum well structure (MQW structure). In the active layer 154, a region corresponding to a non-oxidized region 156a (current passage portion) of the oxide confinement layer 156 to be described later serves as a light-emitting area. Note that the active layer 154 may have a plurality of QW structures or a plurality of MQW structures stacked with a tunnel junction interposed therebetween.

### Second Cladding Layer

The second cladding layer 155 includes, as an example, an AlGaAs-based compound semiconductor of a second conductivity type (for example, p-type).

### Oxide Confinement Layer

The oxide confinement layer 156 includes, as an example, the non-oxidized region 156a including AlAs and an oxidized region 156b including an oxide of AlAs (for example, Al2O3) surrounding the non-oxidized region. The non-oxidized region 156a functions as a current and light passage portion, and the oxidized region 156b functions as a current and light confinement portion.

### Second Multilayer Film Reflector

The second multilayer film reflector 157 is, as an example, a semiconductor multilayer film reflector. More specifically, the second multilayer film reflector 157 is, as an example, a semiconductor multilayer film reflector of the second conductivity type (for example, p-type) , and has a structure in which a plurality of types (for example, two types) of semiconductor layers different in refractive index from each other is alternately stacked with an optical thickness equal to a quarter of the oscillation wavelength. Each refractive index layer of the second multilayer film reflector 157 includes an AlGaAs-based compound semiconductor of the second conductivity type (for example, p-type) .

### First and Second Electrodes

The first and second electrodes e1 and e2 are provided on the second structure S2, electrically isolated from each other.

In FIG. 6, the first electrode e1 is a region enclosed by a chain line, and the second electrode e2 is a region surrounded by a two-dot chain line. The first electrode e1 functions as a cathode electrode and is electrically connected to, for example, a cathode (negative electrode) of the driver. The second electrode e2 functions as an anode electrode and is electrically connected to, for example, an anode (positive electrode) of the driver.

As an example, the first and second electrodes e1 and e2 are arranged on a side (upper side) of the second structure S2 remote from active layer 154 (lower side). More specifically, the first and second electrodes e1 and e2 are, as an example, arranged on the second structure S2 in the stacking direction (vertical direction).

As an example, the second electrode e2 is provided on a surface of the second structure S2 remote from the active layer 154 (more specifically, on the top surface of the second multilayer film reflector 157). The first and second electrodes e1 and e2 are stacked with an insulating film 159 interposed therebetween. More specifically, the first electrode e1 is arranged on the second electrode e2 with the insulating film 159 interposed therebetween.

As an example, the first electrode e1 is smaller than the second electrode e2. As an example, the second electrode e2 is provided across the entire top of the mesa M, except for the outer edge of the top, and the first electrode e1 is provided over one end of the top of the mesa M. As an example, the second electrode e2 has an approximately circular shape in plan view, and the first electrode e1 has an approximately rectangular shape in plan view. Exposed regions of the first electrode e1 and the second electrode e2 serve as, for example, connection regions for connecting to the driver using a flip-chip method.

With wiring 160 partially connected to the first structure S1, the first electrode e1 corresponds to the other part (for example, end) of the wiring 160. The wiring 160 is provided along the mesa M with insulating films 158 and 159 interposed therebetween. That is, the wiring 160 is electrically isolated from the second structure S2. A part of the wiring 160 is in contact with an exposed surface of the first structure S1 around the mesa M (specifically, an exposed surface of the contact layer 151 around the mesa M).

### Wiring

The wiring 160 has, as an example, a multilayer structure (for example, a three-layer structure) in which a first contact metal 160a, a first pad metal 160b, and a first plated metal 160c are stacked in this order.

The first contact metal 160a is provided in contact with the exposed surface of the contact layer 151 around the mesa M.

The first contact metal 160a has, for example, a multilayer structure (for example, a three-layer structure) in which an AuGe layer, a Ni layer, and an Au layer are stacked in this order from the contact layer 151. The AuGe layer has a thickness of, for example, 2 nm to 300 nm. The Ni layer has a thickness of, for example, 2 nm to 300 nm. The Au layer has a thickness of, for example, 100 nm to 500 nm.

The first pad metal 160b has, for example, a multilayer structure (for example, a three-layer structure) in which a Ti layer, a Pt layer, and an Au layer are stacked in this order from the first contact metal 160a and the mesa M. The Ti layer has a thickness of, for example, 2 nm to 100 nm. The Pt layer has a thickness of, for example, 2 nm to 300 nm. The Au layer has a thickness of, for example, 100 nm to 1000 nm.

The first plated metal 160c includes, for example, an Au layer. The Au layer has a thickness of, for example, 1000 nm to 5000 nm. The first plated metal 160c need not necessarily be provided as long as the first pad metal 160b can be formed thicker to prevent breakage and can reduce resistance, for example.

### Insulating Film

The insulating films 158 and 159 each include, for example, a dielectric such as SiO2, SiN, or SiON. Each insulating film has a thickness of, for example, 10 nm to 300 nm.

### Second Electrode

As an example, the second electrode e2 is at least a part (for example, all) of a stacked electrode 161 in the in-plane direction, the stacked electrode 161 having a multilayer structure (for example, a three-layer structure) in which a second contact metal 161a, a second pad metal 161b, and a second plated metal 161c are stacked in this order.

As an example, the second contact metal 161a is provided in contact with the surface (top surface) of the second multilayer film reflector 157 remote from the active layer 154. The second contact metal 161a has, for example, a multilayer structure (for example, a three-layer structure) in which a Ti layer, a Pt layer, and an Au layer are stacked in this order from the second multilayer film reflector 157. The Ti layer has a thickness of, for example, 2 nm to 100 nm. The Pt layer has a thickness of, for example, 2 nm to 300 nm. The Au layer has a thickness of, for example, 100 nm to 500 nm.

The second pad metal 161b has, for example, a multilayer structure (for example, a three-layer structure) in which a Ti layer, a Pt layer, and an Au layer are stacked in this order from the second contact metal 161a. The Ti layer has a thickness of, for example, 2 nm to 100 nm. The Pt layer has a thickness of, for example, 2 nm to 300 nm. The Au layer has a thickness of, for example, 100 nm to 1000 nm.

The second plated metal 161c includes, for example, an Au layer. The Au layer has a thickness of, for example, 1000 nm to 5000 nm. The second plated metal 161c need not necessarily be provided as long as the second pad metal 111b can be formed thicker to prevent breakage and can reduce resistance, for example.

An example of how the light-emitting unit 120 operates will be described. In the light-emitting unit 120, for example, current supplied from the anode of the driver and flowing into the second electrode e2 (anode electrode) passes through the second multilayer film reflector 157, is narrowed by the oxide confinement layer 156, and is injected into the active layer 154. This causes the active layer 154 to emit light, and the light travels back and forth between the first and second multilayer film reflectors 152 and 157 while being amplified by the active layer 154 and confined by the oxide confinement layer 156, and is emitted as laser light from the back surface of the substrate 150 when the oscillation condition is satisfied. The current that has passed through the active layer 154 reaches the first electrode e1 (cathode electrode) through the first cladding layer 153, the first multilayer film reflector 152, and the contact layer 151, and flows out from the first electrode e1 toward, for example, the cathode of the driver.

### CONFIGURATION EXAMPLE OF DRIVE CIRCUIT OF LIGHT-EMITTING UNIT

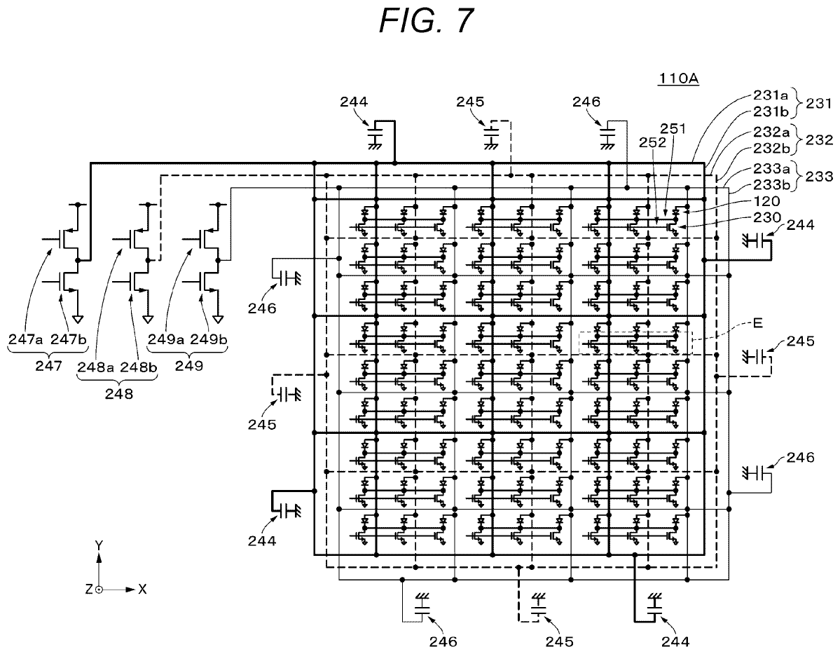

FIG. 7 is a circuit diagram illustrating a configuration example of a drive circuit (drive circuit 110A) of the light-emitting unit 20 according to the embodiments.

FIG. 7 illustrates a plurality of light-emitting units 120 arranged in a two-dimensional array and a plurality of transistors 230 electrically connected to these light-emitting units 120. These transistors 230 are, for example, NMOS transistors. FIG. 7 illustrates, as an example, 9×9 light-emitting units 120 and 9×9 transistors 230. Needless to say, the number of the light-emitting units 120 and the number of the transistors 230 are not limited to the above example.

As illustrated in FIG. 7, the drive circuit 110A of the present embodiment further includes a first anode line 231, a second anode line 232, a third anode line 233, a plurality of first capacitors 244, a plurality of second capacitors 245, a plurality of third capacitors 246, a first selection circuit 247, a second selection circuit 248, a third selection circuit 249, a plurality of cathode lines 251, and a plurality of gate lines 252.

The first anode line 231 includes a plurality of first horizontal lines 231a extending in the horizontal direction (X direction) and a plurality of first vertical lines 231b extending in the vertical direction (Y direction). Similarly, the second anode line 232 includes a plurality of second horizontal lines 232a extending in the horizontal direction and a plurality of second vertical lines 232b extending in the vertical direction. Similarly, the third anode line 233 includes a plurality of third horizontal lines 233a extending in the horizontal direction and a plurality of third vertical lines 233b extending in the vertical direction. FIG. 7 illustrates, as an example, five first horizontal lines 231a, five first vertical lines 231b, five second horizontal lines 232a, five second vertical lines 232b, five third horizontal lines 233a, and five third vertical lines 233b.

The first selection circuit 247 includes transistors 247a and 247b. Similarly, the second selection circuit 248 includes transistors 248a and 248b. Similarly, the third selection circuit 249 includes transistors 249a and 249b. The transistors 247a, 248a, and 249a are, for example, PMOS transistors. The transistors 247b, 248b, and 249b are, for example, NMOS transistors.

In FIG. 7, in order to differentiate among the first to third anode lines 231 to 233, the first anode line 231 is indicated by a bold solid line, the second anode line 232 is indicated by a bold dashed line, and the third anode line 233 is indicated by a thin solid line.

The first anode line 231 has a structure in which the plurality of first horizontal lines 231a and the plurality of first vertical lines 231b are arranged in a mesh pattern. The first horizontal lines 231a and the first vertical lines 231b are electrically connected to each other at points where the first horizontal lines 231a and the first vertical lines 231b intersect. Similarly, the second anode line 232 includes the plurality of second horizontal lines 232a and the plurality of second vertical lines 232b electrically connected to each other, and the third anode line 233 includes the plurality of third horizontal lines 233a and the plurality of third vertical lines 233b electrically connected to each other. On the other hand, the first to third anode lines 231 to 233 are electrically isolated from each other.

The first to third horizontal lines 231a to 233a extend in the X direction (horizontal direction) and are adjacent to each other in the Y direction (vertical direction). The first to third horizontal lines 231a to 233a linearly extend in the X direction in FIG. 7, but may extend in a curved shape in the X direction. That is, the first to third horizontal lines 231a to 233a may include bent sections.

On the other hand, the first to third vertical lines 231b to 233b extend in the Y direction and are adjacent to each other in the X direction. The first to third vertical lines 231b to 233b linearly extend in the Y direction in FIG. 7, but may extend in a curved shape in the Y direction. That is, the first to third vertical lines 231b to 233b may include bent sections.

FIG. 7 illustrates five sets of first to third horizontal lines 231a to 233a. In FIG. 7, the first to third horizontal lines 231a to 233a of the first, second, third, fourth, and fifth sets are arranged in this order from top to bottom. In each set, the first horizontal line 231a, the second horizontal line 232a, and the third horizontal line 233a are arranged in this order from top to bottom. The first to third horizontal lines 231a to 233a of the first set and the first to third horizontal lines 231a to 233a of the fifth set are arranged to place 9×9 light-emitting units 120 therebetween. Each of the first to third horizontal lines 231a to 233a of the second to fourth sets is arranged along a row of (nine) light-emitting units 120.

FIG. 7 further illustrates five sets of first to third vertical lines 231b to 233b. In FIG. 7, the first to third vertical lines 231b to 233b of the first, second, third, fourth, and fifth sets are arranged in this order from left to right. In each set, the first vertical line 231b, the second vertical line 232b, and the third vertical line 233b are arranged in this order from left to right. The first to third vertical lines 231b to 233b of the first set and the first to third vertical lines 231b to 233b of the fifth set are arranged to place 9×9 light-emitting units 120 therebetween. Each of the first to third vertical lines 231b to 233b of the second to fourth sets is arranged along a row of (nine) light-emitting units 120.

The anode (second electrode e2 described above) of each light-emitting unit 120 is electrically connected to any one of the first to third vertical lines 231b to 233b. For example, the light-emitting units 120 in the leftmost column are electrically connected to the first vertical line 231b among the first to third vertical lines 231b to 233b of the second set. Furthermore, the light-emitting units 120 in the rightmost column are electrically connected to the third vertical line 233b among the first to third vertical lines 231b to 233b of the fourth set. Note that the anode of each light-emitting unit 120 may be electrically connected to any one of the first to third horizontal lines 231a to 233a instead of being electrically connected to any one of the first to third vertical lines 231b to 233b.

Each cathode line 251 extends in the X direction and is electrically connected to the cathodes (first electrodes e1 described above) of three light-emitting units 120. Specifically, each cathode line 251 is electrically connected to one light-emitting unit 120 electrically connected to the first vertical line 231b, one light-emitting unit 120 electrically connected to the second vertical line 232b, and one light-emitting unit 120 electrically connected to the third vertical line 233b. These three light-emitting units 120 are adjacent to each other in the X direction. FIG. 7 illustrates 27 cathode lines 251 for the 81 light-emitting units 120.

Each light-emitting unit 120 is provided between the corresponding anode line, that is, any one of the first to third anode lines 231 to 233 and the corresponding cathode line, that is, any one of the plurality of cathode lines 251. Each light-emitting unit 120 emits light when current flows between the corresponding anode line and the corresponding cathode line.

Each gate line 252 extends in the X direction and is electrically connected to the gates of three transistors 230. These three transistors 230 have their sources electrically connected to a ground line (GND), and have their drains electrically connected to the same single cathode line 251. These three transistors 230 form one drive circuit E. FIG. 7 illustrates 27 gate lines 252 for 81 transistors 230.

Each drive circuit E is electrically connected to the cathodes of the three light-emitting units 120 through one cathode line 251. Each drive circuit (output stage) E is used to drive the light-emitting unit 120 to generate (output) light from the light-emitting unit 120. For example, in a case where light is generated from one light-emitting unit 120, a predetermined signal is applied to the gate line 252 of the drive circuit E for the light-emitting unit 120. This causes continuity between the source and drain of each transistor 230 in the drive circuit E, allowing current to flow through the light-emitting unit 120. When current flows through the light-emitting unit 120, light is generated from the light-emitting unit 120. The drive circuit 110A illustrated in FIG. 7 includes 27 drive circuits E for the 81 light-emitting units 120.

The first to third selection circuits 247 to 249 are electrically connected to the first to third horizontal lines 231a to 233a of the first to third anode lines 231 to 233, respectively. The first selection circuit 247 is used to select a light-emitting unit 120 electrically connected to the first anode line 231 as the light-emitting unit 120 that generates light. The second selection circuit 248 is used to select a light-emitting unit 120 electrically connected to the second anode line 232 as the light-emitting unit 120 that generates light. The third selection circuit 249 is used to select a light-emitting unit 120 electrically connected to the third anode line 233 as the light-emitting unit 120 that generates light. The first to third selection circuits 247 to 249 may be electrically connected to first to third vertical lines 231b to 233b of first to third anode lines 231~233, respectively, instead of the first to third horizontal lines 231a to 233a of the first to third anode lines 231 to 233.

It is possible to cause, by selecting appropriate light-emitting units 120 using the first to third selection circuits 247 to 249, a plurality of light-emitting units 120 to emit light in a switchable manner for each light-emitting unit 120 or for each group of light-emitting units 120 belonging to a predetermined region.

The first selection circuit 247 includes a transistor 247a having its source electrically connected to a power supply line (VDD) and a transistor 247b having its source electrically connected to the ground line. The transistor 247a and the transistor 247b have their drains electrically connected to the first anode line 231. The first selection circuit 247 is electrically connected to each of the first capacitors 244 through the first anode line 231.

The transistor 247a is used to store charge in each of the first capacitors 244. The transistor 247b is used to discharge each of the first capacitors 244. When a predetermined signal is applied to the gate of the transistor 247a, charge is stored in each of the first capacitors 244. When a predetermined signal is applied to the gate of the transistor 247b, each of the first capacitors 244 is discharged. Therefore, according to the present embodiment, selectively storing charge in the first capacitors 244 among the first to third capacitors 244 to 246 using the first selection circuit 247 allows current to flow through each light-emitting unit 120 electrically connected to the first anode line 231.

As illustrated in FIG. 7, the second and third selection circuits 248 and 249 are similar in structure to the first selection circuit 247. Therefore, according to the present embodiment, selectively storing charge in each of the second capacitors 245 using the second selection circuit 248 allows current to flow through each light-emitting unit 120 electrically connected to the second anode line 232. Moreover, according to the present embodiment, selectively storing charge in each of the third capacitor 246 using the third selection circuit 249 allows current to flow through each light-emitting unit 120 electrically connected to the third anode line 233.

The first to third capacitors 244 to 246 are electrically connected to the first to third anode lines 231 to 233, respectively. Each of the first capacitors 244 stores charge to be supplied to the light-emitting units 120 electrically connected to the first anode line 231. Each of the second capacitors 245 stores charge to be supplied to the light-emitting units 120 electrically connected to the second anode line 232. Each of the third capacitors 246 stores charge to be supplied to the light-emitting units 120 electrically connected to the third anode line 233. According to the present embodiment, supplying charge from the first to third capacitors 244 to 246 to each light-emitting unit 120 allows current to flow through each light-emitting unit 120. Each of the first to third capacitors 244 to 246 includes a first electrode electrically connected to any one of the first to third anode lines 231 to 233 and a second electrode electrically connected to the ground line.

The drive circuit 110A illustrated in FIG. 7 includes 9×9 light-emitting units 120 arranged in a two-dimensional array. As illustrated in FIG. 7, each light-emitting unit 120 has an approximately square shape in plan view. The drive circuit 110A illustrated in FIG. 7 includes four sets of the first to third capacitors 244 to 246 near the four sides of the square.

Specifically, the first to third capacitors 244 to 246 of the first set is provided near the top edge of the square, the first to third capacitors 244 to 246 of the second set is provided near the right edge of the square, the first to third capacitors 244 to 246 of the third set is provided near the bottom edge of the square, and the first to third capacitors 244 to 246 of the fourth set is provided near the left edge of the square.

The first to third capacitors 244 to 246 of the first and third sets are electrically connected to the first to third horizontal lines 231a to 233a of the first to third anode lines 231 to 233, respectively. On the other hand, the first to third capacitors 244 to 246 of the second and fourth sets are electrically connected to the first to third vertical lines 231b to 233b of the first to third anode lines 231 to 233, respectively. As a result, the first to third capacitors 244 to 246 illustrated in FIG. 7 are electrically connected to the first to third anode lines 231 to 233, respectively.

In each set, the first to third capacitors 244 to 246 are arranged in clockwise order. For example, the first capacitor 244, the second capacitor 245, and the third capacitor 246 of the first set are arranged near the top edge of the square, at the left, center, and right positions, respectively.

Furthermore, the first capacitor 244, the second capacitor 245, and the third capacitor 246 of the second set are arranged near the right edge of the square, at the upper, center, and lower positions, respectively. As a result, the four sets of first to third capacitors 244 to 246 illustrated in FIG. 7 are arranged symmetrically with respect to the center of the square. The center of the square approximately corresponds to the position of the light-emitting unit 120 in the fifth row and fifth column among the 9×9 light-emitting units 120. In FIG. 7, the arrangement of the four sets of first to third capacitors 244 to 246 is four-fold rotational symmetry (90-degree rotational symmetry).

According to the present embodiment, an average distance between each light-emitting unit 120 and the corresponding four capacitors can be set close to an average distance between another light-emitting unit 120 and the corresponding four capacitors.

For example, the light-emitting unit 120 at the top left corner is close to the upper first capacitor 244 but is far from the lower first capacitor 244. On the other hand, the light-emitting unit 120 at the bottom right corner is close to the right third capacitor 246 but is far from the left third capacitor 246. Therefore, the average distance between the light-emitting unit 120 at the top left corner and the four first capacitors 244 becomes close to the average distance between the light-emitting unit 120 at the bottom right corner and the four third capacitors 246. This is similarly true for the other 79 light-emitting units 120. With this configuration, regarding the anode line between each light-emitting unit 120 and the corresponding four capacitors, it is possible to reduce an impedance difference between the lines of different light-emitting units 120.

The drive circuit 110A of the present embodiment may include the first to third capacitors 244 to 246 only near one, two, or three of the four edges of the square. Even in this case, it is still desirable that the first to third capacitors 244 to 246 be arranged symmetrically or nearly symmetrically with respect to the center of the square. Therefore, the drive circuit 110A of the present embodiment desirably includes the first to third capacitors 244 to 246 on two or more of the four edges of the square. For example, arranging two sets of the first to third capacitors 244 to 246 near the top and bottom edges of the square achieves two-fold rotational symmetry (180-degree rotational symmetry).

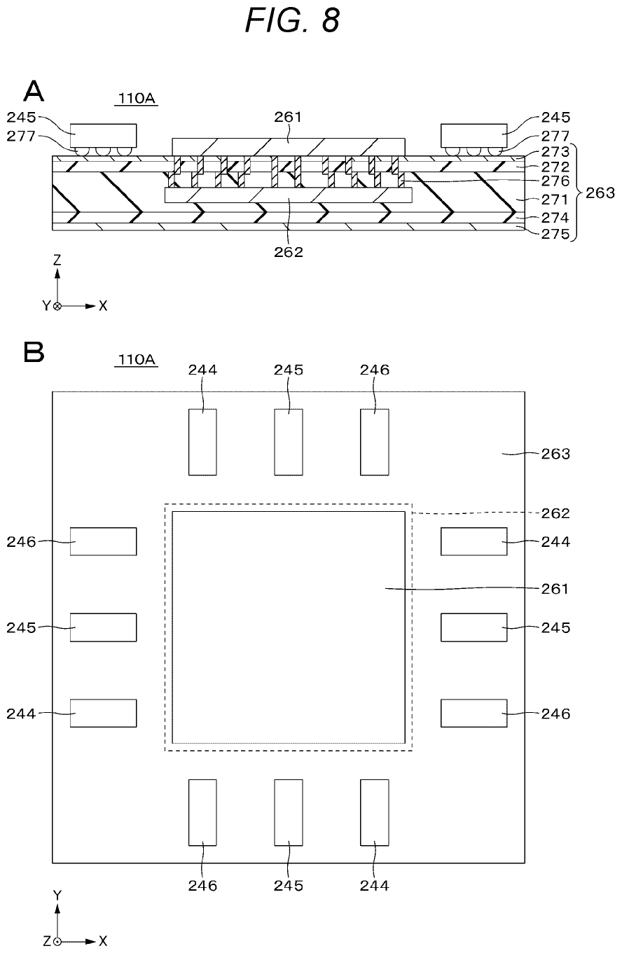

FIGS. 8A and 8B are a cross-sectional view and plan view illustrating a structure of the drive circuit 110A according to the embodiment. In FIGS. 8A and 8B, the drive circuit 110A of the present embodiment includes a chip 261, a driver 262, a mounting substrate 263, and the four sets of first to third capacitors 244 to 246. The driver 262 is configured to drive the components of the drive circuit 110A.

The mounting substrate 263 is, for example, a substrate corresponding to the above-described substrate 150. More specifically, the mounting substrate 263 includes, for example, an insulating substrate 271, an insulating film 272, a wiring layer 273, an insulating film 274, a wiring layer 275, and a plurality of lines (vias) 276. The driver 262 illustrated in FIG. 8A is provided in, for example, the insulating substrate 271. The insulating film 272 and the wiring layer 273 are sequentially formed on the top surface of the insulating substrate 271. The insulating film 274 and the wiring layer 275 are sequentially formed on the bottom surface of the insulating substrate 271. The chip 261 illustrated in FIG. 8A is provided on the wiring layer 273. Each line 276 is formed in the insulating substrate 271, the insulating film 272, and the wiring layer 273, and electrically connects the chip 261 and the driver 262.

Each of the first to third capacitors 244 to 246 is arranged on the wiring layer 273 with a plurality of solder balls 277 interposed therebetween, and is electrically connected to the chip 261 and the driver 262 through the solder balls 277 and the wiring layer 273.

In FIG. 8B, the chip 261 and the driver 262 each have a square shape in plan view. The drive circuit 110A illustrated in FIG. 8B includes the four sets of first to third capacitors 244 to 246 near the four edges of the square that is the planar shape of the chip 261. The first to third capacitors 244 to 246 are arranged symmetrically with respect to the center of the square. Note that the drive circuit 110A illustrated in FIG. 8B may include the first to third capacitors 244 to 246 only near one, two, or three of the four edges of the square. Even in this case, it is still desirable that the first to third capacitors 244 to 246 be arranged symmetrically or nearly symmetrically with respect to the center of the square. Therefore, the drive circuit 110A illustrated in FIG. 8B desirably includes the first to third capacitors 244 to 246 on two or more of the four edges of the square.

In FIGS. 8A and 8B, the plurality of light-emitting units 120, the plurality of transistors 230, and the first to third selection circuits 247 to 249 (see FIG. 7) are provided in, for example, the chip 261 or the driver 262. For example, the light-emitting units 120 are provided in the chip 261. On the other hand, the transistors 230 and the first to third selection circuits 247 to 249 may be provided in the chip 261 or the driver 262. Note that the first to third capacitors 244~246 may be arranged on the chip 261 or the mounting substrate 263.

The configuration example of the light-emitting unit 120 and the configuration example of the drive circuit 110A described above are merely examples, and light-emitting units and drive circuits having different configurations can be applied to the lighting device 10.

### FIRST EMBODIMENT

Next, a plurality of configuration examples of the lighting device 10 will be described. The lighting device 10 includes, for example, a light-emitting element 110 including a plurality of light-emitting units 120 arranged in an array, a first optical member arranged near the light-emitting element 110, the first optical member being arranged in the emission direction of light beams emitted from the light-emitting units 120 to reduce a gap between the light beams emitted from the light-emitting units 120 adjacent to each other and make the light beams uniform in light intensity, and a second optical member that roughly collimates divergent light from the first optical member. The first optical member can also function as an optical functional member that makes the light-emitting area larger for each light-emitting unit 120 to make the non-irradiation area between the light-emitting units 120 smaller. Note that the position near the light-emitting element 110 is, for example, a position at a distance of 2 mm or less, preferably 1 mm or less, from the light-emitting element 110.

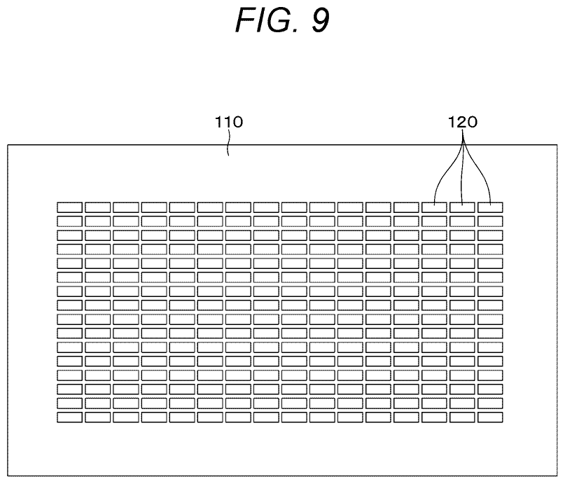

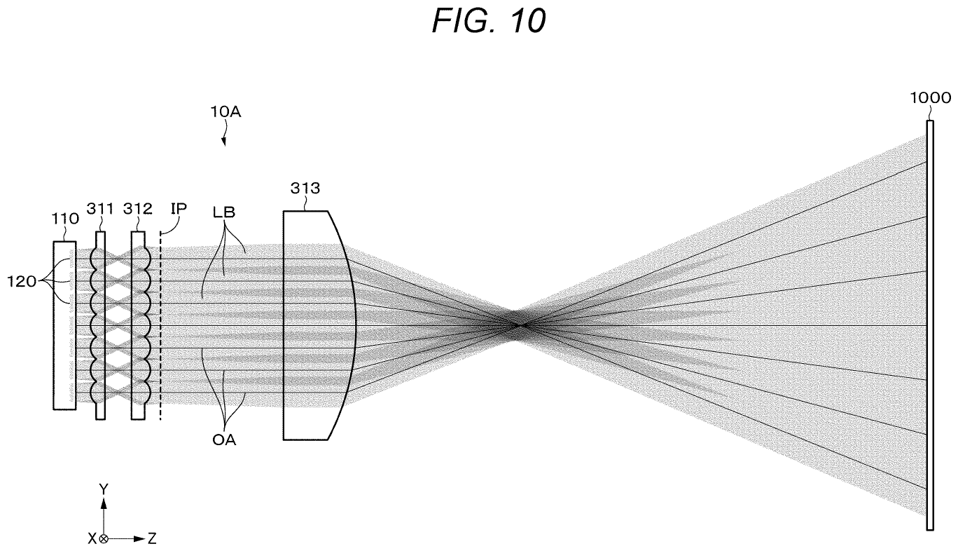

A configuration example of a lighting device (lighting device 10A) according to the first embodiment will be described with reference to FIGS. 9 and 10. FIG. 9 illustrates an example of the light-emitting units 120 arranged in an array and the light-emitting element 110 including the light-emitting units 120. In the illustrated example, the light-emitting units 120 are arranged in a rectangular shape, but the present disclosure is not limited to the example. The light-emitting units 120 may be arranged in a circular shape, an elliptical shape, or a polygonal shape. Furthermore, the number of the illustrated light-emitting units 120 is also merely an example, and the number of the light-emitting units 120 is not limited to the illustrated example.

As illustrated in FIG. 10, the lighting device 10A includes a first microlens array 311, a second microlens array 312, and a collimator lens 313, in addition to the light-emitting element 110 including the plurality of light-emitting units 120 arrayed in an array. The first microlens array 311 and the second microlens array 312 are examples of the first optical member, and the collimator lens 313 is an example of the second optical member. More specifically, the first microlens array 311 is an example of the first lens unit, and the second microlens array 312 is an example of the second lens unit. As illustrated in FIG. 10, the first microlens array 311, the second microlens array 312, and the collimator lens 313 are arranged in this order from the light-emitting element 110. Note that, although seven light-emitting units 120 are illustrated in FIG. 10, the number of light-emitting units 120 may be determined as desired. This also applies to the other embodiments.

Each light-emitting unit 120 according to the present embodiment is, for example, a top-emitting VCSEL. The first microlens array 311 causes the light beams LB emitted from the light-emitting units 120 to converge. The second microlens array 312 roughly collimates divergent light beams LB after being converged by the first microlens array 311. The collimator lens 313 roughly collimates divergent light from the second microlens array 312. The light beams LB that have passed through the collimator lens 313 diverge after being converged to the focal point, and are applied to the irradiation target 1000.

The magnification (lateral magnification) of an image formed by the light beams LB can be increased by the first microlens array 311 and the second microlens array 312. It is therefore possible to eliminate gaps between the light beams LB at the position of an intermediate image (intermediate image position IP), and it is possible to eliminate gaps for the light irradiation to the irradiation target 1000 after the collimator lens 313. Note that the intermediate image position IP is also referred to as a telecentric position, is a position formed by the first optical member, and more specifically, is a position separated by the focal length of the collimator lens 313 in a −Z direction in FIG. 10.

A ratio between the light-emitting area of the light-emitting units 120 and an image at the intermediate image position changes (the latter becomes larger) due to the effect of the first microlens array 311 (the effect of increasing the lateral magnification). Accordingly, the focal length of the second microlens array 312 is made larger than the focal length of the first microlens array 311. That is, the first microlens array 311 and the second microlens array 312 according to the present embodiment have different optical characteristics.

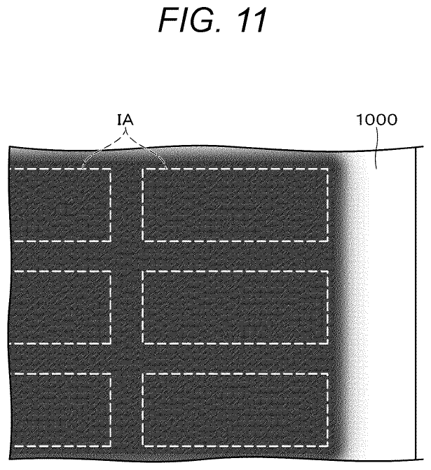

FIG. 11 is a diagram schematically illustrating a state where the irradiation target 1000 is irradiated with the light beams LB emitted from the lighting device 10A. In FIG. 11, a black or gray area indicates where the irradiation target 1000 is irradiated with light. In FIG. 11, for easy understanding, an irradiation area IA for each light-emitting unit 120 without the first microlens array 311 and the second microlens array 312 is indicated by a dotted line. An irradiation range can be increased by the effects of the first microlens array 311 and second microlens array 312, and a gap (for example, the gap GA illustrated in FIG. 3) present between the irradiation areas IA can be reduced (to zero or to a predetermined size or less). The predetermined size or less means that, for example, in a case where the lighting device 10A is applied to a ranging device, the size of the gap GA is small enough to accurately measure the distance to the irradiation target 1000. For example, according to the present embodiment, in a case where the angle of the non-irradiation range (the angle viewed from the direction in FIG. 1 or the like) is denoted by Δθ, the irradiation range of one side of each light beam can be enlarged by about Δθ/2 by the first optical member.

That is, the gap present between the irradiation areas IA can be reduced without defocusing the light beams. As a result, the spread of light outside the light-irradiation area is suppressed, thereby improving the light utilization efficiency.

This eliminates the need for increasing the light output, and can suppress an increase in the size, cost, and power consumption of the lighting device, as well as an increase in the load on the lighting device 10A. Furthermore, it is possible to suppress a decrease in the light intensity of the light-irradiation area, thereby making it possible to prevent decreases and variations in the measurement range. Note that such effects can also be achieved in the other embodiments to be described below.

### MODIFICATIONS OF FIRST EMBODIMENT

### Modification 1

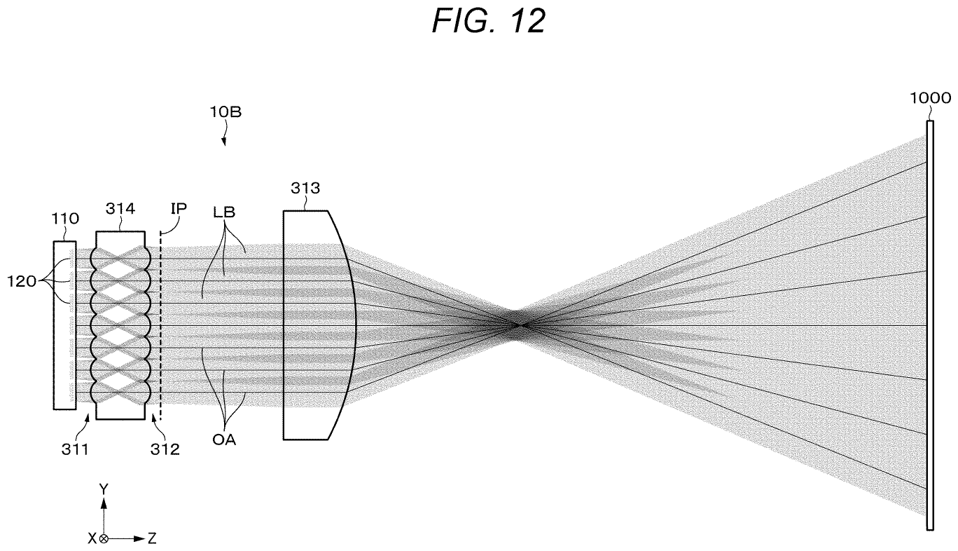

Next, a modification of the first embodiment will be described. FIG. 12 is a diagram for describing a configuration example of a lighting device (lighting device 10B) according to a modification 1. As illustrated in FIG. 12, the lighting device 10B according to the modification 1 includes a lens member 314 as an example of the first optical member. The lens member 314 is arranged near the light-emitting element 110. The lens member 314 has the first microlens array 311 and the second microlens array 312 integrated into a single lens member, with the first microlens array 311 formed on one main surface and the second microlens array 312 formed on the other main surface. The other components are similar to those of the first embodiment. The present modification has the advantage of being able to reduce the number of components, in addition to the effects described in the first embodiment.

### Modification 2

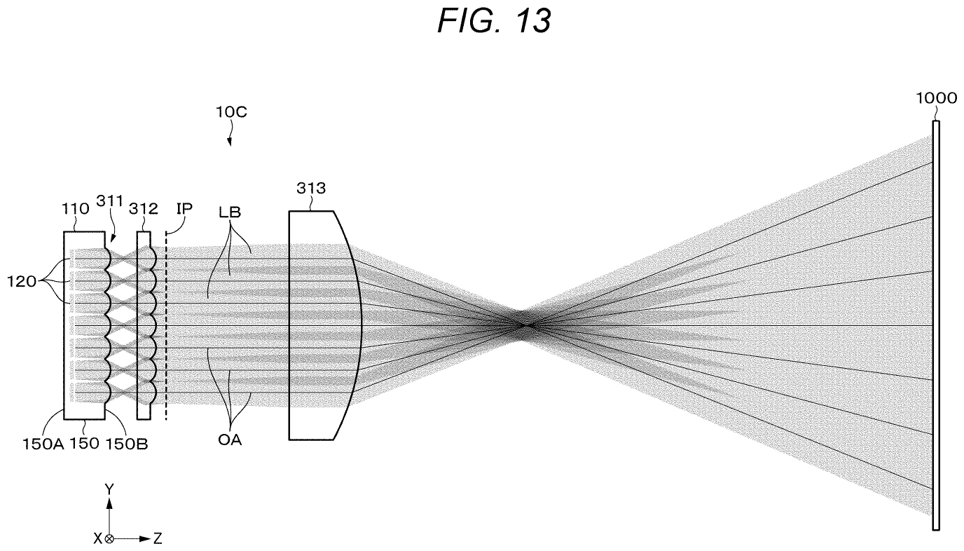

FIG. 13 is a diagram for describing a configuration example of a lighting device (lighting device 10C) according to a modification 2. As illustrated in FIG. 13, a light-emitting element 110 included in the lighting device 10C is not a top-emitting VCSEL but a bottom-emitting VCSEL. For example, the light-emitting units 120 are formed on a first main surface 150A of the substrate 150 of the light-emitting element 110. Then, the light beams LB from the light-emitting units 120 are emitted from a second main surface 150B opposite to the first main surface 150A.

The first microlens array 311 is formed on the second main surface 150B. The first microlens array 311 is integrally formed as an on-chip lens with respect to the substrate 150. The effects described in the first embodiment and modification 1 can also be achieved by the lighting device 10C.

### Modification 3

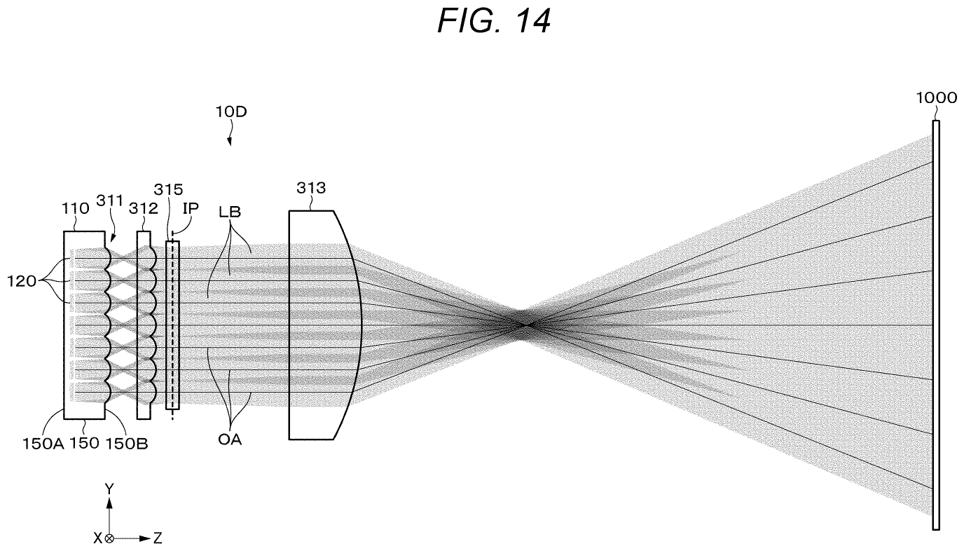

FIG. 14 is a diagram for describing a configuration example of a lighting device (lighting device 10D) according to a modification 3. The lighting device 10D is different from the lighting device 10C in that a diffusion plate 315 is arranged at the intermediate image position IP.

The use of the relay optical system including the first microlens array 311 and the second microlens array 312 narrows a far field pattern (FFP) of the light beams LB from the light-emitting units 120. As a result, there is a possibility that the laser safety for human eyes will decrease even at the same light output.

In the lighting device 10D according to the present modification, the diffusion plate 315 is arranged between the second microlens array 312 and the collimator lens 313, more specifically, at the intermediate image position IP. The diffusion plate 315 thus arranged can enlarge the FFP and improve the laser safety. Furthermore, even in a case where a person looks near the light-emitting element 110 of the lighting device 10D, it is possible to prevent the person from directly looking at the light-emitting element 110 due to the diffusion plate 315. It is therefore possible to improve the safety of the lighting device 10D.

Note that the second microlens array 312 and the diffusion plate 315 are separated in the example illustrated in FIG. 14, but may be integrated into a single optical component with the second microlens array 312 and the diffusion plate 315 formed on both surfaces of a base member.

The diffusion plate 315 according to the present embodiment may be a diffraction grating. As the diffraction grating, for example, a diffraction grating with fine parallel slits provided on a flat surface such as glass can be used. Each light beam LB that has passed through the second microlens array 312 is split by the diffraction grating and then emitted.

### Modification 4

Microlenses constituting the first microlens array 311 and the second microlens array 312, and the collimator lens 313 may be metalenses (devices with minute nanostructures).

### SECOND EMBODIMENT

Next, a second embodiment will be described. Note that, in the description of the second embodiment, components that are identical or similar to those in the above description are denoted by the same reference numerals as used in the above description to omit redundant descriptions as appropriate.

Furthermore, the matters described in the first embodiment can be applied to the second embodiment unless otherwise specified.

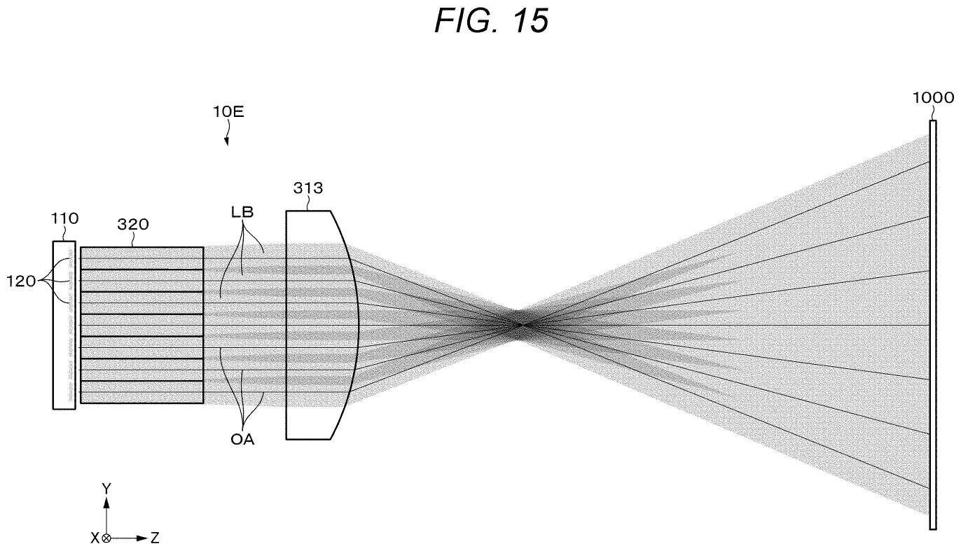

FIG. 15 is a diagram for describing a configuration example of a lighting device (lighting device 10E) according to the second embodiment. The lighting device 10E includes, in addition to the light-emitting element 110 and the collimator lens 313, a rod lens array 320 (the first optical member in the present embodiment) arranged near the light-emitting element 110. The rod lens array 320 makes the light intensity of the light beams LB emitted from the light-emitting units 120 approximately uniform.

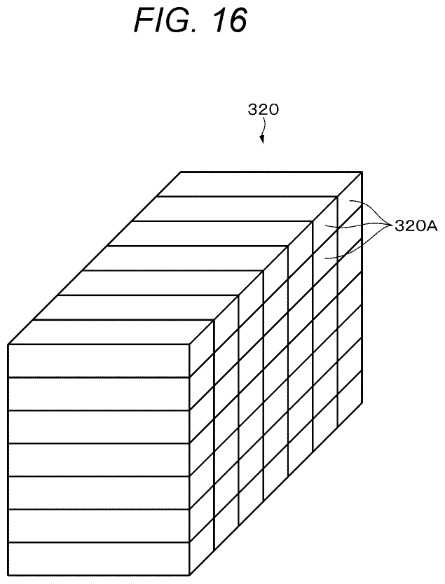

As illustrated in FIG. 16, the rod lens array 320 has, for example, a shape in which prism rod lenses 320A are two-dimensionally bonded. The number of rod lenses 320A corresponds to the number of light-emitting units 120. That is, the light beam LB emitted from a certain light-emitting unit 120 impinges on one end surface of the corresponding rod lens 320A.

The light beam LB entering the rod lens 320A is repeatedly reflected by the rod lens 320A, and then emitted from an end surface opposite to the incident end surface. The light beams LB emitted from the light-emitting units 120 are converted into random and homogenized (uniform) light beams by being repeatedly reflected in the rod lenses 320A. The light beams LB that have passed through the rod lens array 320 are applied to the irradiation target 1000 through the collimator lens 313. The light beams LB that have passed through the rod lens array 320 are converted into random and uniform light beams LB, allowing the irradiation target 1000 to be irradiated with light without gaps.

### MODIFICATIONS OF SECOND EMBODIMENT

### Modification 1

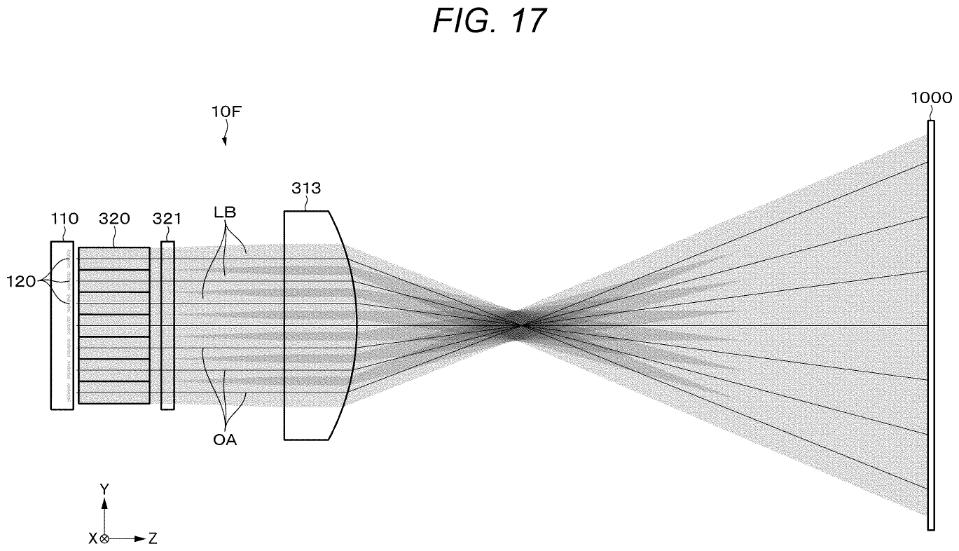

FIG. 17 is a diagram for describing a configuration example of a lighting device (lighting device 10F) according to a modification 1 of the second embodiment. The lighting device 10F includes the rod lens array 320 arranged near the light-emitting element 110, similar to the lighting device 10E described above. Furthermore, a diffusion plate 321 is arranged between the rod lens array 320 and the collimator lens 313 of the lighting device 10F and adjacent to the rod lens array 320.

With the diffusion plate 321 in place, it is possible to enlarge the irradiation range of the light beams LB not only with the rod lens array 320 but also with the diffusion plate 321. This configuration can make the length (optical path length) of the rod lens array 320 shorter and downsize the lighting device 10F. Furthermore, with the diffusion plate 321 in place, it is possible to improve the safety of the lighting device 10F.

Note that the rod lens array 320 and the diffusion plate 321 are separated in the example illustrated in FIG. 17, but may be integrated into a single optical component with the diffusion plate 315 provided on the emission surface of the rod lens array 320.

The diffusion plate 321 according to the present embodiment may be a diffraction grating. As the diffraction grating, for example, a diffraction grating with fine parallel slits provided on a flat surface such as glass can be used.

### THIRD EMBODIMENT

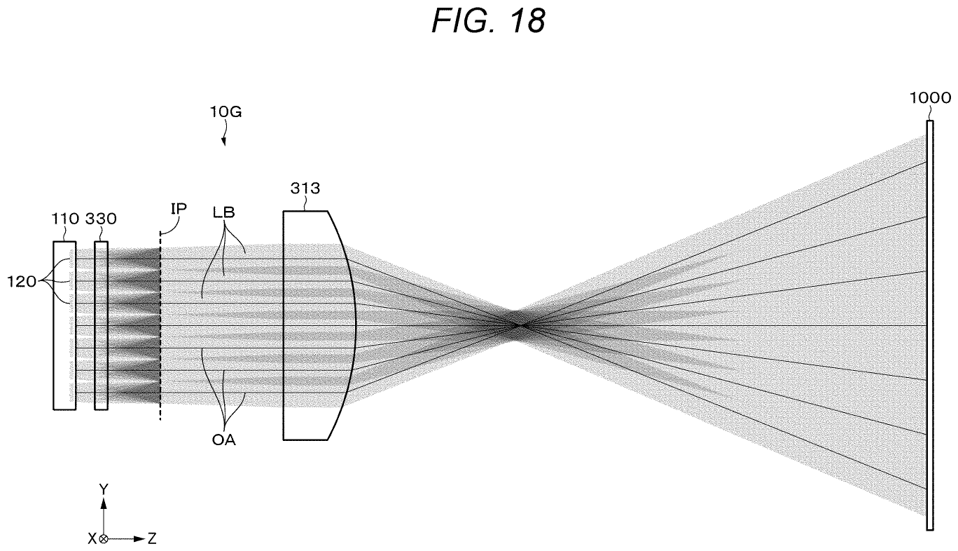

FIG. 18 is a diagram for describing a configuration example of a lighting device (lighting device 10G) according to a third embodiment. The lighting device 10G includes a diffraction grating 330 (the first optical member in the present embodiment) arranged near the light-emitting element 110. The diffraction grating 330 diffracts the light beams LB emitted from the light-emitting units 120 to spread the light beams LB. Even in a case where the light intensity distribution of the light-emitting element 110 is large, the lighting device 10G can achieve uniform light intensity due to the effect of the diffraction grating 330.

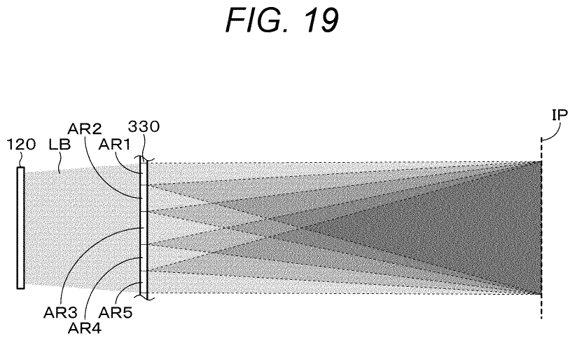

The diffraction grating 330 has small regions with different diffraction characteristics in a zone corresponding to one light-emitting unit 120. For example, as illustrated in FIG. 19, a zone of the diffraction grating 330 corresponding to one light-emitting unit 120 is segmented into five small regions (small regions AR1, AR2, AR3, AR4, and AR5), and the small regions have different diffraction characteristics. The diffraction grating 330 is segmented into a predetermined number of (five in this example) small regions, and has a diffraction characteristic that causes the light beams LB that have passed through the small regions to overlap at the intermediate image position IP.

As the diffraction grating 330, for example, a Fresnel lens can be used. For the central small region AR3, a Fresnel lens that enlarges the overall irradiation range can be used. Then, the further from the center, the more eccentric the Fresnel lens becomes, that is, for example, for the small region AR1, an eccentric Fresnel lens having a diffraction characteristic that causes the light beam LB to spread downward in the drawing is used. For example, for the small region AR5, an eccentric Fresnel lens having a diffraction characteristic that causes the light beam LB to spread upward is used.

According to the present embodiment, even if the intensity of the light beams LB in the light-emitting area of the light-emitting unit 120 becomes non-uniform, the light beams LB applied to the irradiation target 1000 are uniform, and the non-uniformity of the measurement range can be reduced.

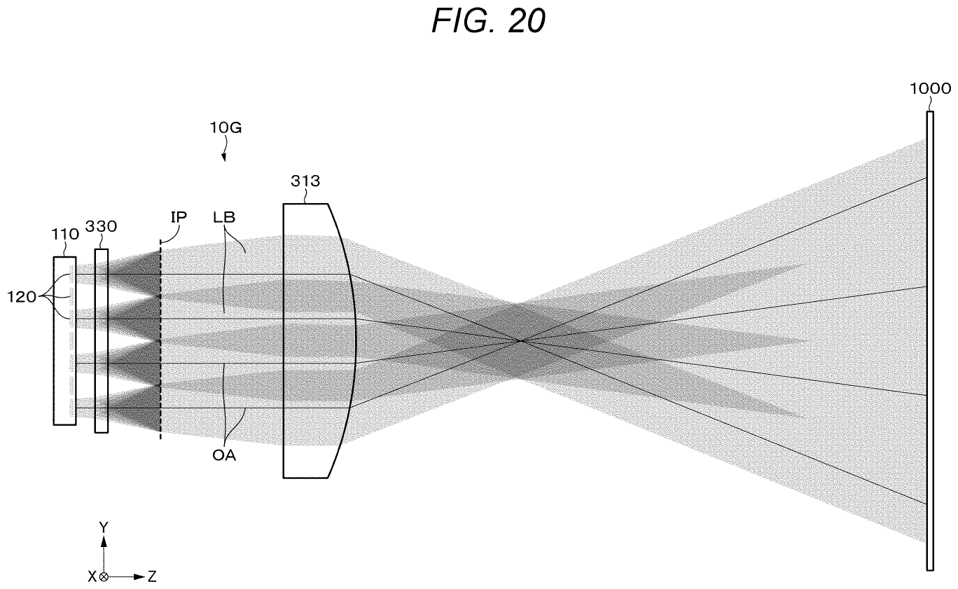

In the present embodiment, at the intermediate image position IP, the light-irradiation area of each light-emitting unit 120 may overlap the light-irradiation areas of the other light-emitting units 120. As a result, for example, as illustrated in FIG. 20, even in a case where every other light-emitting unit 120 is controlled to emit light, it is possible to irradiate the irradiation target 1000 with the light beams LB without gaps. With such a configuration, even in a case where the light emission of light-emitting units 120 belonging to one group and the light emission of light-emitting units 120 belonging to another group are switched, it is possible to irradiate the irradiation target 1000 with the light beams LB without gaps and increase the frame rate. Furthermore, even in a case where one light-emitting unit 120 fails and does not emit light, it is possible to prevent, by causing an adjacent light-emitting unit 120 to emit light, the non-irradiation area from being generated.

### MODIFICATIONS OF THIRD EMBODIMENT

### Modification 1

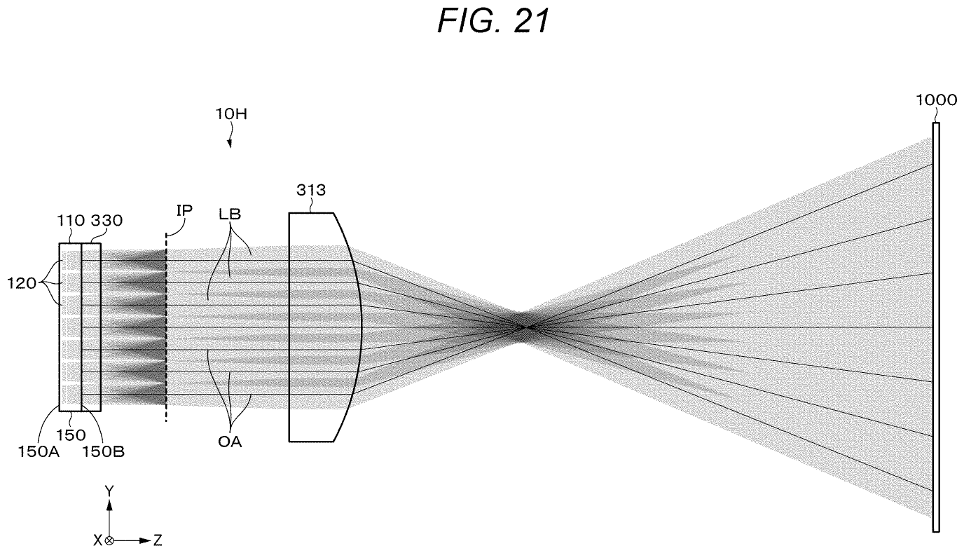

FIG. 21 is a diagram for describing a configuration example of a lighting device (lighting device 10H) according to a modification 1 of the third embodiment. As illustrated in FIG. 21, the light-emitting element 110 may be a bottom-emitting VCSEL. In this case, the diffraction grating 330 described above may be formed as an on-chip lens on the second main surface 150B of the substrate 150 of the light-emitting element 110.

### Modification 2

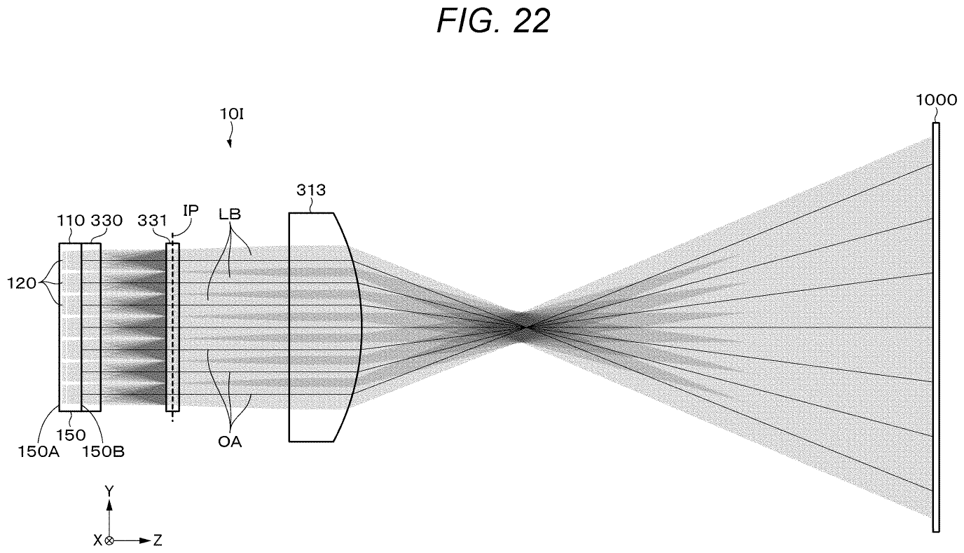

FIG. 22 is a diagram for describing a configuration example of a lighting device (lighting device 10I) according to a modification 2 of the third embodiment. As illustrated in FIG. 22, in the configuration illustrated in FIG. 21, a diffusion plate 331 may be arranged at the intermediate image position IP located between the diffraction grating 330 and the collimator lens 313. Such a configuration can make the emission direction of the light beam LB emitted from each small region uniform and thus can improve the laser safety. Note that, although not illustrated in the drawings, the diffraction grating 330 and the diffusion plate 331 may be integrated into a single optical component with the diffraction grating 330 and the diffusion plate 331 formed on both surfaces of a base member.

### FOURTH EMBODIMENT

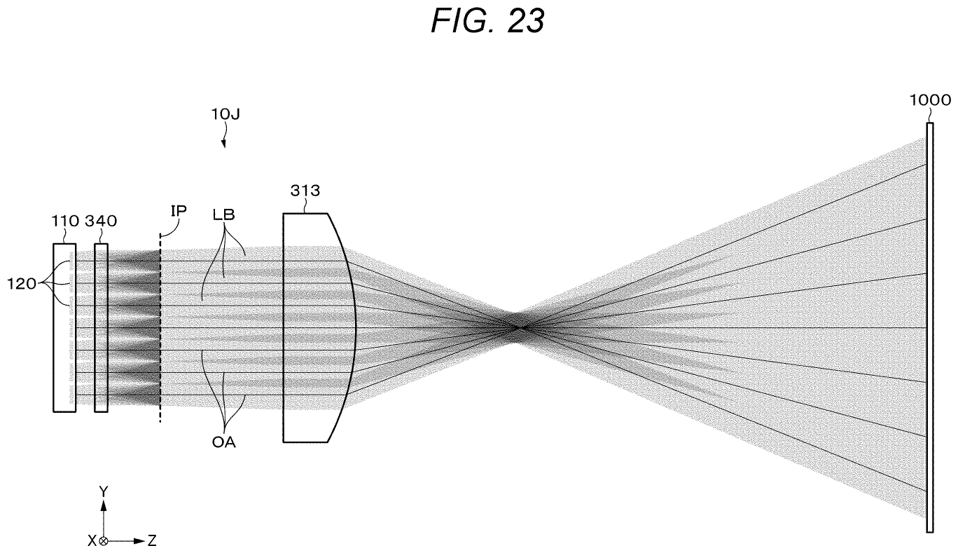

FIG. 23 is a diagram for describing a configuration example of a lighting device (lighting device 10J) according to a fourth embodiment. The lighting device 10J includes a freeform lens 340 (the first optical member in the present embodiment) arranged near the light-emitting element 110.

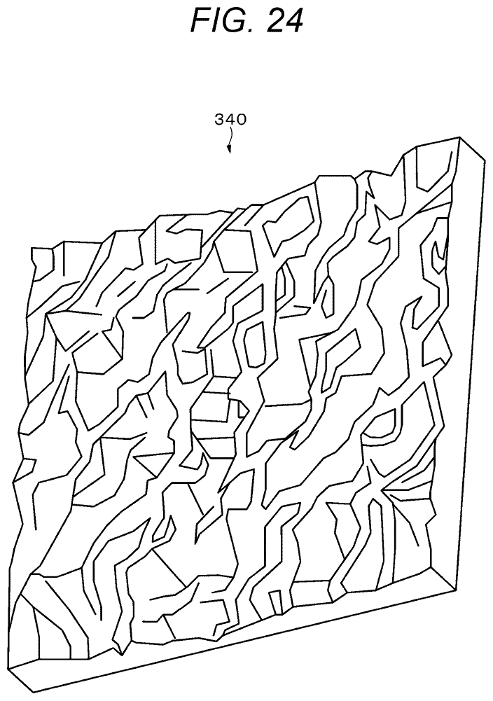

FIG. 24 illustrates an example of the freeform lens 340. The freeform lens is, for example, a lens whose surface that refracts light to form an image is non-circular and not rotationally symmetric. As illustrated in FIG. 24, the surface of the freeform lens 340 that refracts light has recesses to obtain desired refractive characteristics. By forming the recesses, protrusions are locally formed on the surface that refracts light. Similar to the diffraction grating 330 described above, the freeform lens 340 has different refractive characteristics for each small region.

The light beams LB emitted from the light-emitting units 120 are refracted by the freeform lens 340. This allows the irradiation target 1000 to be irradiated with light without gaps, similar to the first embodiment and the like.

### MODIFICATIONS OF FOURTH EMBODIMENT

### Modification 1

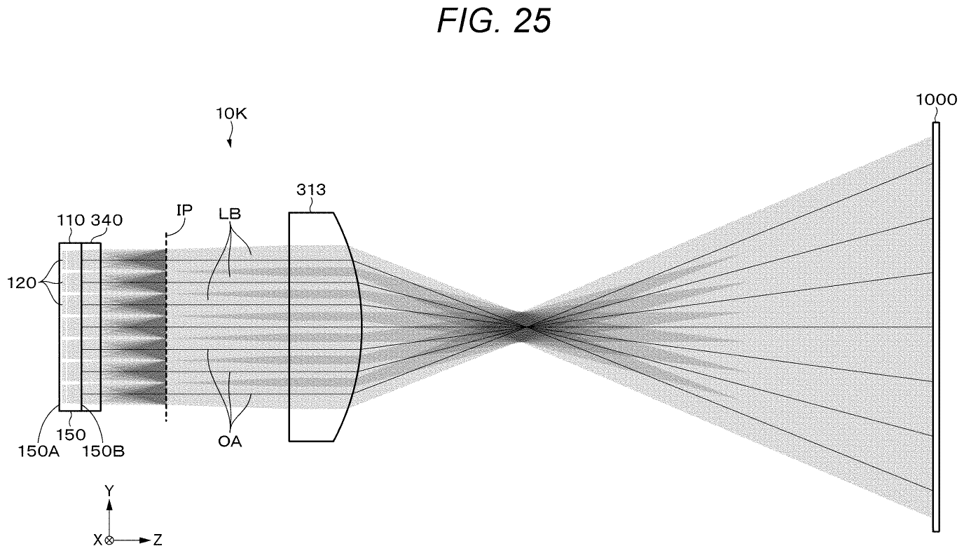

FIG. 25 is a diagram for describing a configuration example of a lighting device (lighting device 10K) according to a modification 1 of the fourth embodiment. As illustrated in FIG. 25, the light-emitting element 110 may be a bottom-emitting VCSEL. In this case, the freeform lens 340 described above may be formed as an on-chip lens on the second main surface 150B of the substrate 150 of the light-emitting element 110.

### Modification 2

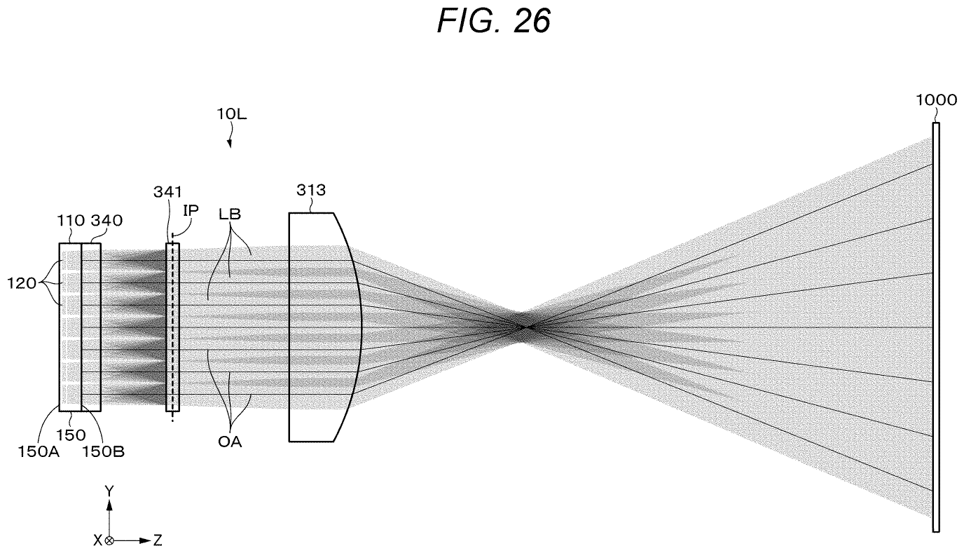

FIG. 26 is a diagram for describing a configuration example of a lighting device (lighting device 10L) according to a modification 2 of the fourth embodiment. As illustrated in FIG. 26, in the configuration illustrated in FIG. 25, a diffusion plate 341 may be arranged at the intermediate image position IP located between the freeform lens 340 and the collimator lens 313. Such a configuration can make the emission direction of the light beam LB emitted from each small region uniform and thus can improve the laser safety. Note that, although not illustrated in the drawings, the freeform lens 340 and the diffusion plate 341 may be integrated into a single optical component with the freeform lens 340 and the diffusion plate 341 formed on both surfaces of a base member. Furthermore, the diffusion plate 341 may be a diffraction grating.

### FIFTH EMBODIMENT

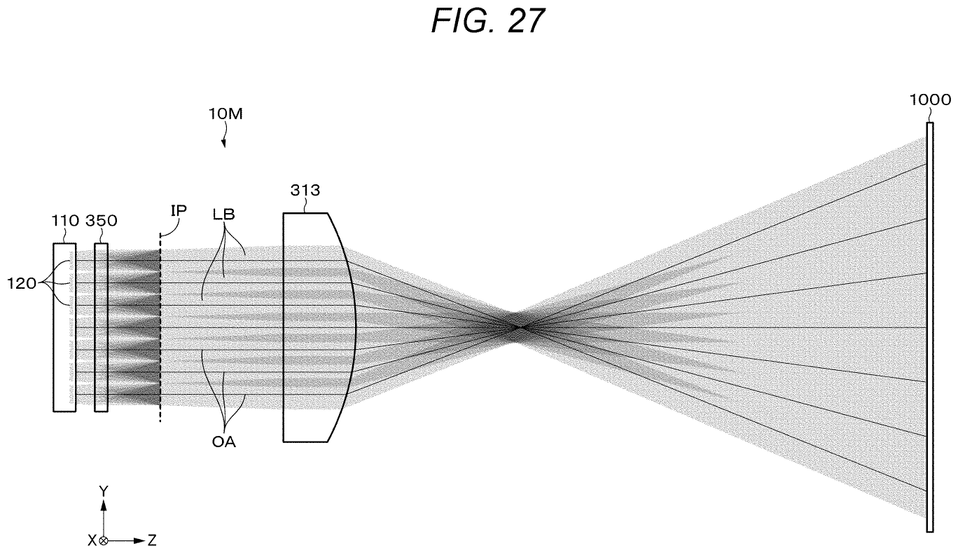

FIG. 27 is a diagram for describing a configuration example of a lighting device (lighting device 10M) according to a fifth embodiment. The lighting device 10M includes a metamaterial 350 (the first optical member in the present embodiment) arranged near the light-emitting element 110. Here, the metamaterial refers to an artificially designed substance having characteristics not found in nature, and in the present embodiment, the metamaterial refers to a metamaterial for light. Similar to the diffraction grating 330 described above, the metamaterial 350 has different refractive characteristics for each small region.

The light beams LB emitted from light-emitting units 120 are refracted by a metamaterial surface of the metamaterial 350. This allows the irradiation range to be enlarged in a similar manner to the first embodiment and the like.

### Modification 1

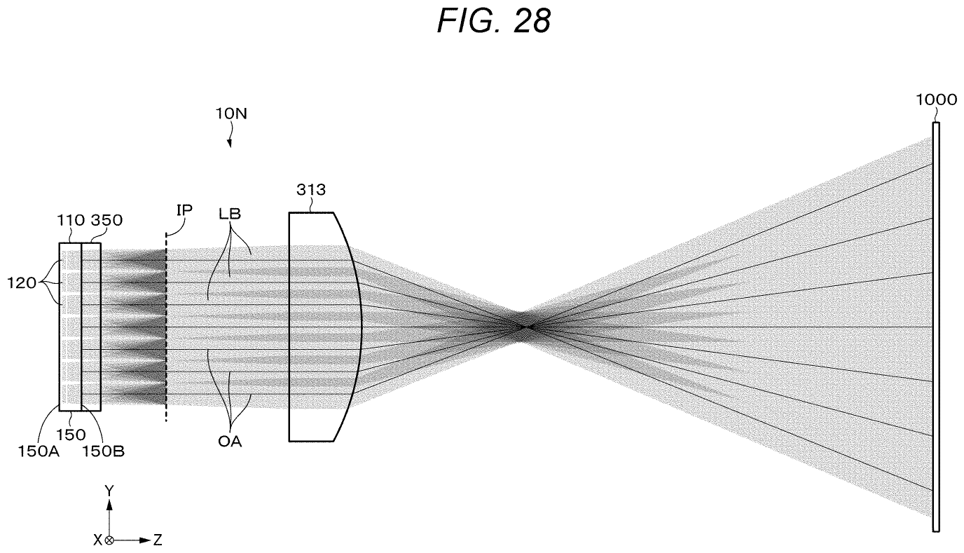

FIG. 28 is a diagram for describing a configuration example of a lighting device (lighting device 10N) according to a modification 1 of the fifth embodiment. As illustrated in FIG. 28, the light-emitting element 110 according to the present embodiment may be a bottom-emitting VCSEL. In this case, the metamaterial 350 described above may be formed as an on-chip lens on the second main surface 150B of the substrate 150 of the light-emitting element 110.

### Modification 2

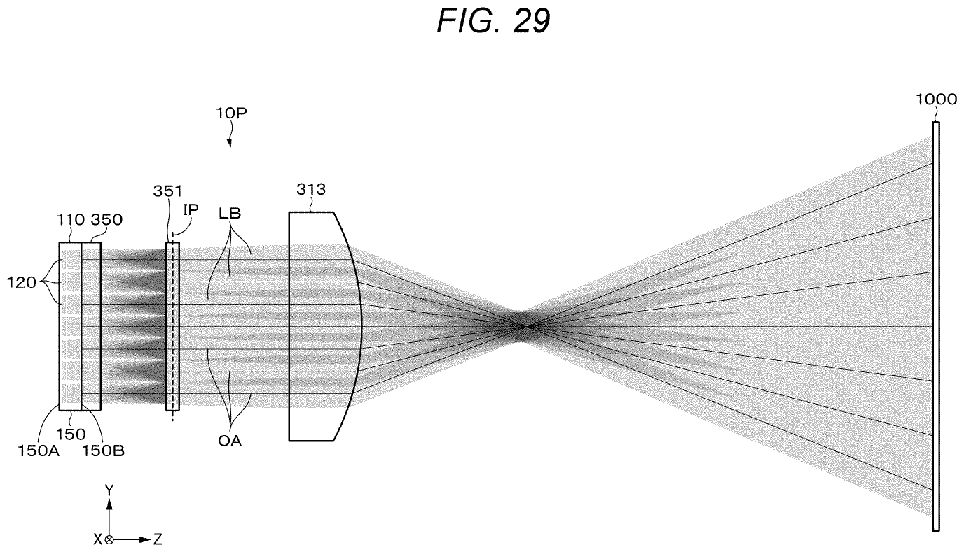

FIG. 29 is a diagram for describing a configuration example of a lighting device (lighting device 10P) according to a modification 2 of the fifth embodiment. As illustrated in FIG. 29, in the configuration example illustrated in FIG. 28, a diffusion plate 351 may be arranged at the intermediate image position IP. Such a configuration can make the emission direction of the light beam LB emitted from each small region uniform and thus can improve the laser safety. Note that, although not illustrated in the drawings, the metamaterial 350 and the diffusion plate 351 may be integrated into a single optical component with the metamaterial 350 and the diffusion plate 351 formed on both surfaces of a base member. Furthermore, the diffusion plate 351 may be a diffraction grating.

### SIXTH EMBODIMENT

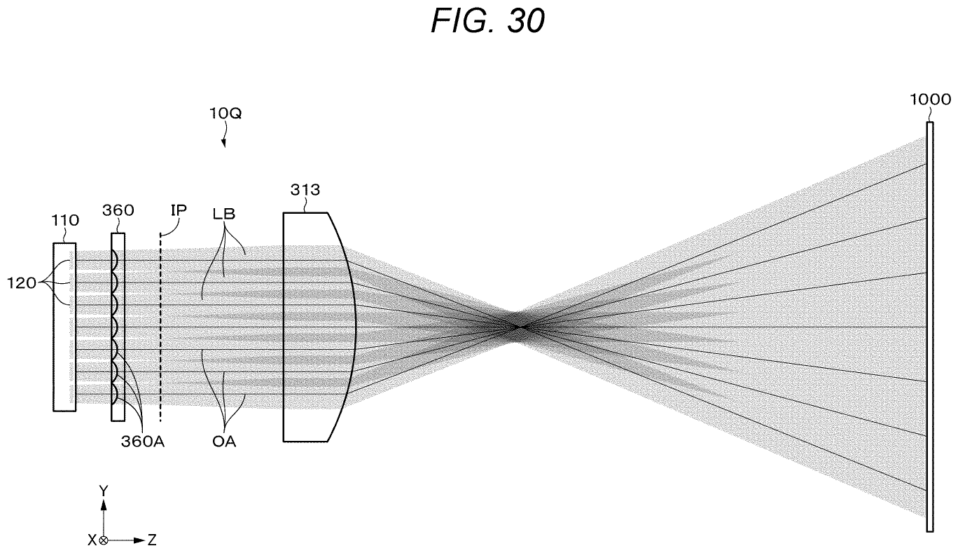

FIG. 30 is a diagram for describing a configuration example of a lighting device (lighting device 100) according to a sixth embodiment. The lighting device 100 includes a concave lens array 360 (the first optical member in the present embodiment) arranged near the light-emitting element 110.

The concave lens array 360 includes a plurality of concave lenses 360A arranged in an array. The plurality of concave lenses 360A is provided in a one-to-one relationship with the plurality of light-emitting units 120.

The light beam LB emitted from each light-emitting unit 120 is refracted by the corresponding concave lens 360A of the concave lens array 360. This allows the irradiation range to be enlarged in a similar manner to the first embodiment and the like.

### Modification 1

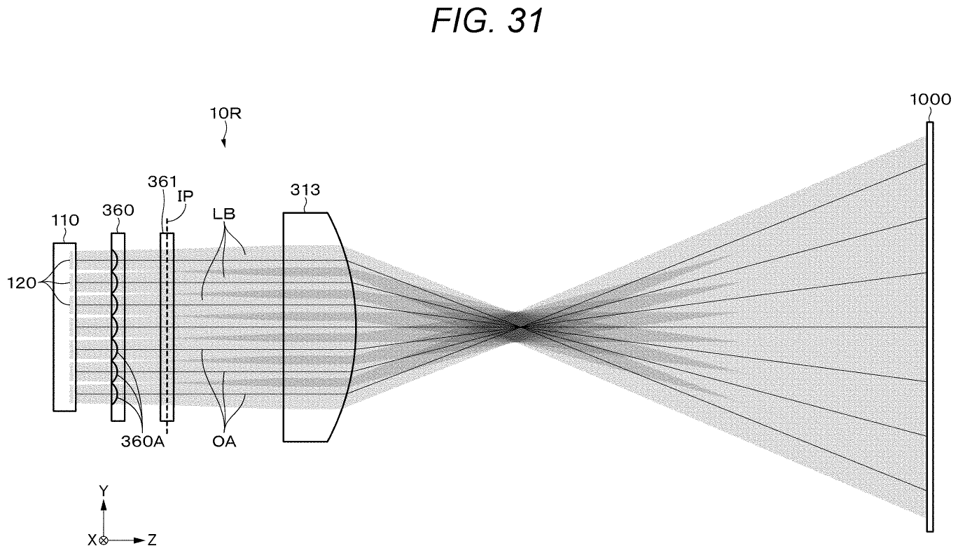

FIG. 31 is a diagram for describing a configuration example of a lighting device (lighting device 10R) according to a modification 1 of the sixth embodiment. As illustrated in FIG. 31, a diffusion plate 361 may be arranged at the intermediate image position IP. Such a configuration can make the emission direction of the light beam LB emitted from each small region uniform and thus can improve the laser safety. Note that, although not illustrated in the drawings, the concave lens array 360 and the diffusion plate 361 may be integrated into a single optical component with the concave lens array 360 and the diffusion plate 361 formed on both surfaces of a base member.

### Modification 2

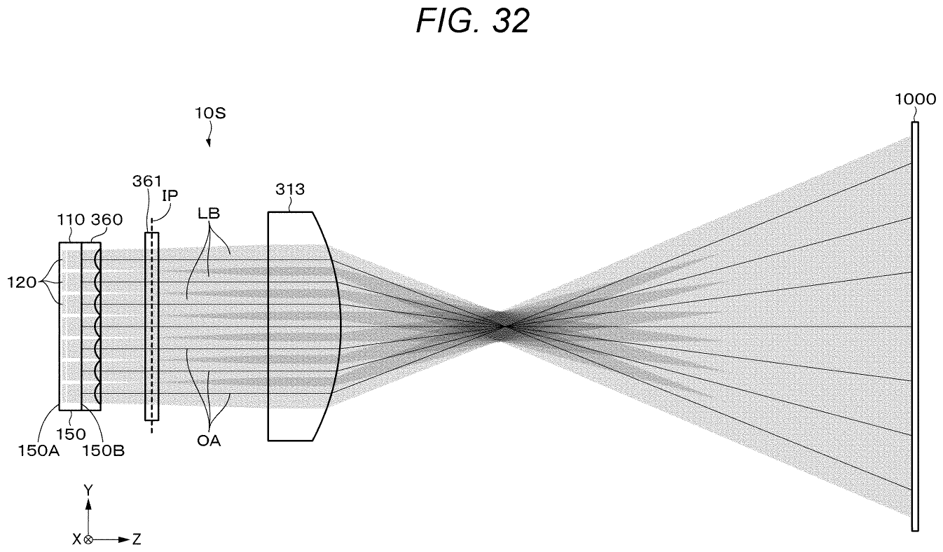

FIG. 32 is a diagram for describing a configuration example of a lighting device (lighting device 10S) according to a modification 2 of the sixth embodiment. As illustrated in FIG. 32, the light-emitting element 110 according to the present embodiment may be a bottom-emitting VCSEL. In this case, the concave lens surface of each concave lens 360A described above may be formed as an on-chip lens on the second main surface 150B of the substrate 150 of the light-emitting element 110.

### Modification 3

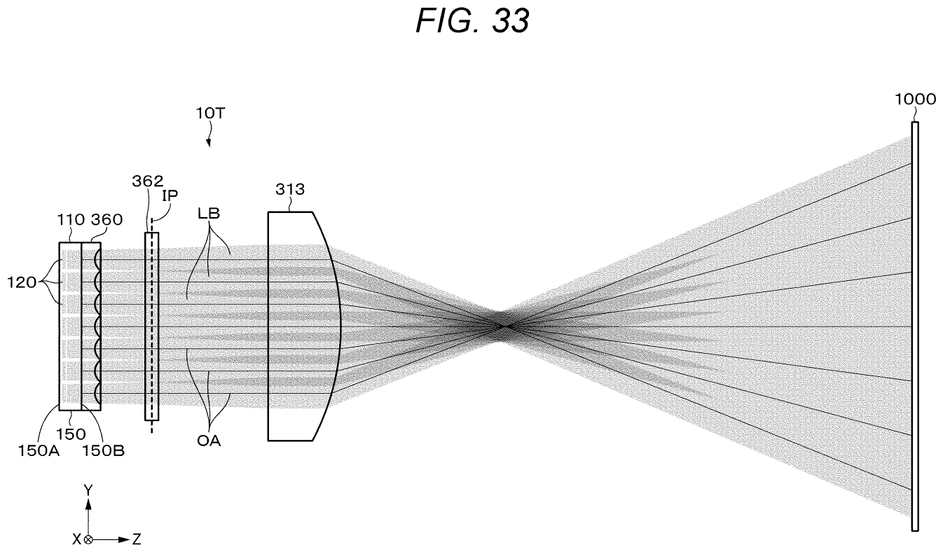

FIG. 33 is a diagram for describing a configuration example of a lighting device (lighting device 10T) according to a modification 3 of the sixth embodiment. As illustrated in FIG. 33, a diffraction grating 362 may be arranged at the intermediate image position IP instead of the diffusion plate 361. The diffraction grating 362 facilitates the miniaturization of the grating pattern for making the emission direction of the light beam emitted from each small region uniform, as compared with the diffusion plate 361. It is therefore possible to suppress changes in characteristics (changes in diffusion/diffracted light distribution) due to misalignment of the diffraction grating 362.

Examples of the diffraction grating 362 include a diffraction grating that generates, in a two-dimensional, bidirectional matrix, 15×15 dot diffracted light using ±7th-order diffracted light in a case where each light beam LB emitted from the light-emitting element 110 is considered the zero order. As for the diffraction order, fewer dots such as ±7th, ±3rd, or ±2nd order are acceptable. Furthermore, the diffraction dot pattern is not limited to a square or rectangular diffraction dot pattern, and may be a circular diffraction dot pattern. In a case of the circular diffraction dot pattern, the lens diameter of the collimator lens 313 can be effectively used, leading to the improvement of the light utilization diffraction dot pattern and the miniaturization of the lens.

### MODIFICATIONS

Although the embodiments of the present disclosure have been described in detail above, the content of the present disclosure is not limited to the above-described embodiments, and various modifications based on the technical idea of the present disclosure are possible.

Furthermore, the configurations, methods, processes, shapes, materials, numerical values, and the like of the above-described embodiments may be modified as necessary without departing from the gist of the present disclosure. Furthermore, the plurality of configuration examples described in one embodiment may be combined or replaced with each other.

Note that the effects described herein are merely illustrative and not limiting, and other effects may also be present.

Note that the present technology may also have the following configurations.
(1)

A lighting device including:
a light-emitting element including a plurality of light-emitting units arranged in an array;
a first optical member arranged near the light-emitting element, the first optical member being arranged in an emission direction of light beams emitted from the light-emitting units to reduce a gap between the light beams emitted from the light-emitting units adjacent to each other and make the light beams uniform in light intensity; and
a second optical member that roughly collimates divergent light from the first optical member.
(2)

The lighting device according to (1), in which
the first optical member includes a first lens unit that causes the light beam emitted from each of the light-emitting units to converge, and a second lens unit that roughly collimates a divergent light beam after being converged by the first lens unit.
(3)

The lighting device according to (2), in which
the first lens unit and the second lens unit are integrated into a single lens unit.
(4)

The lighting device according to (2), in which
the light-emitting element includes a substrate, and
the plurality of light-emitting units is provided on a first main surface of the substrate, and the first lens unit is provided on a second main surface opposite to the first main surface.
(5)

The lighting device according to (1), in which
the first optical member includes a rod lens array that makes the light beam emitted from each of the light-emitting units approximately uniform in light intensity.
(6)

The lighting device according to (1), in which
the first optical member includes a diffraction grating that spreads the light beam emitted from each of the light-emitting units.
(7)

The lighting device according to (6), in which
the diffraction grating splits the light beam emitted from a predetermined one of the light-emitting units into a predetermined number of regions, and light beams from the regions overlap at a position of an intermediate image.
(8)

The lighting device according to (6) or (7), in which
the light-emitting element includes a substrate, and
the plurality of light-emitting units is provided on a first main surface of the substrate, and the diffraction grating is provided on a second main surface opposite to the first main surface.
(9)

The lighting device according to (1), in which
the first optical member includes a freeform lens that spreads the light beam emitted from each of the light-emitting units.

(10)

The lighting device according to (9), in which
the light-emitting element includes a substrate, and
the plurality of light-emitting units is provided on a first main surface of the substrate, and the freeform lens is provided on a second main surface opposite to the first main surface.
(11)

The lighting device according to (1), in which
the first optical member includes a metamaterial that spreads the light beam emitted from each of the light-emitting units.
(12)

The lighting device according to (11), in which
the light-emitting element includes a substrate, and
the plurality of light-emitting units is provided on a first main surface of the substrate, and the metamaterial is provided on a second main surface opposite to the first main surface.
(13)

The lighting device according to any one of (1) to (12), in which
a diffusion plate or a diffraction grating is arranged at a position of an intermediate image formed by the first optical member.
(14)

The lighting device according to (13), in which
the first optical member includes a concave lens that spreads the light beam emitted from each of the light-emitting units, and
the diffusion plate is arranged between the concave lens and the second optical member.
(15)

The lighting device according to (14), in which
the light-emitting element includes a substrate, and
the plurality of light-emitting units is provided on a first main surface of the substrate, and the concave lens is provided on a second main surface opposite to the first main surface.
(16)

The lighting device according to any one of (1) to (15), in which
each of the light-emitting units includes a surface-emitting laser.
(17)

The lighting device according to any one of (1) to (16), in which
the plurality of light-emitting units is capable of emitting light in a switchable manner for each light-emitting unit or for each group of light emitting units belonging to a predetermined region.
(18)

A lighting device including:
a light-emitting element including a plurality of light-emitting units arranged in an array; and
an optical functional member provided near the light-emitting element, the optical functional member being configured to make a light-emitting area larger for each of the light-emitting units and make a non-irradiation area between the light-emitting units smaller.
(19)

A ranging device including the lighting device according to any one of (1) to (18).

### APPLICATION EXAMPLES

Furthermore, the technology according to the present technology can be applied to various products without being limited to the application examples described above. For example, the technology according to the present technology may also be embodied as a device mounted on any kind of mobile body such as an automobile, an electric vehicle, a hybrid electric vehicle, a motorcycle, a bicycle, a personal mobility, an airplane, a drone, a vessel, a robot, a construction machine, or an agricultural machine (tractor).

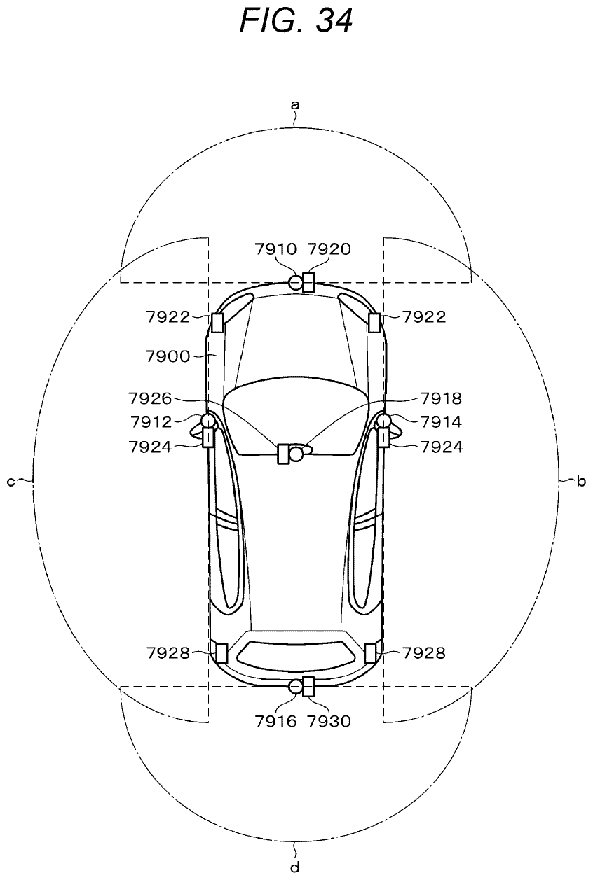

FIG. 34 is a block diagram illustrating a schematic configuration example of a vehicle control system 7000 as an example of a mobile body control system to which the technology according to the present technology can be applied. The vehicle control system 7000 includes a plurality of electronic control units connected to each other via a communication network 7010.

In the example illustrated in FIG. 34, the vehicle control system 7000 includes a drive system control unit 7100, a body system control unit 7200, a battery control unit 7300, an outside-vehicle information detecting unit 7400, an in-vehicle information detecting unit 7500, and an integrated control unit 7600. The communication network 7010 connecting the plurality of control units to each other may be, for example, a vehicle-mounted communication network compliant with any standard such as controller area network (CAN), local interconnect network (LIN), or local area network (LAN), FlexRay (registered trademark).

Each control unit includes: a microcomputer that performs calculation processing in accordance with various programs; a storage section that stores the programs to be executed by the microcomputer, parameters used for various computations, or the like; and a drive circuit that drives various control target devices. Each control unit further includes: a network interface (I/F) for communicating with other control units via the communication network 7010; and a communication I/F for communicating with a device, a sensor, or the like inside or outside the vehicle via wired or wireless communication. FIG. 34 illustrates, as functional components of the integrated control unit 7600, a microcomputer 7610, a general-purpose communication I/F 7620, a dedicated communication I/F 7630, a positioning section 7640, a beacon receiving section 7650, an in-vehicle device I/F 7660, a sound/image output section 7670, a vehicle-mounted network I/F 7680, and a storage section 7690. The other control units similarly include a microcomputer, a communication I/F, a storage section, and the like.

The drive system control unit 7100 controls the operation of devices related to the drive system of the vehicle in accordance with various programs. For example, the drive system control unit 7100 functions as a control device for a driving force generating device for generating the driving force of the vehicle, such as an internal combustion engine or a driving motor, a driving force transmitting mechanism for transmitting the driving force to wheels, a steering mechanism for adjusting the steering angle of the vehicle, a braking device for generating the braking force of the vehicle, and the like. The drive system control unit 7100 may have a function as a control device of an antilock brake system (ABS), electronic stability control (ESC), or the like.

The drive system control unit 7100 is connected with a vehicle state detecting section 7110. The vehicle state detecting section 7110 includes at least one of a gyroscope sensor that detects the angular velocity of axial rotational movement of a vehicle body, an acceleration sensor that detects the acceleration of the vehicle, or sensors for detecting the amount of operation of an accelerator pedal, the amount of operation of a brake pedal, the steering angle of a steering wheel, the engine speed, the rotational speed of wheels, and the like, for example. The drive system control unit 7100 performs calculation processing using signals input from the vehicle state detecting section 7110, and controls the internal combustion engine, the driving motor, an electric power steering device, the braking device, and the like.

The body system control unit 7200 controls the operation of various devices installed in the vehicle body in accordance with various programs. For example, the body system control unit 7200 functions as a control device for a keyless entry system, a smart key system, a power window device, or various lamps such as a headlamp, a backup lamp, a brake lamp, a turn signal, and a fog lamp. In this case, radio waves transmitted from a mobile device that serves as a key, or signals of various switches can be input to the body system control unit 7200. Upon receipt of these input radio waves or signals, the body system control unit 7200 controls a door lock device, the power window device, the lamps, or the like of the vehicle.

The battery control unit 7300 controls a secondary battery 7310, which is a power supply source for the driving motor, in accordance with various programs. For example, the battery control unit 7300 is supplied with information about a battery temperature, a battery output voltage, a battery state of charge, or the like from a battery device including the secondary battery 7310. The battery control unit 7300 performs calculation processing using these signals, and regulates the temperature of the secondary battery 7310 or controls a cooling device installed in the battery device or the like.

The outside-vehicle information detecting unit 7400 detects information about the outside of the vehicle including the vehicle control system 7000. For example, the outside-vehicle information detecting unit 7400 is connected with at least one of an imaging section 7410 or an outside-vehicle information detecting section 7420. The imaging section 7410 includes at least one of a time of flight (ToF) camera, a stereo camera, a monocular camera, an infrared camera, or any other camera. The outside-vehicle information detecting section 7420 includes at least one of an environmental sensor for detecting the current atmospheric conditions or weather conditions, or a surrounding information detecting sensor for detecting another vehicle, an obstacle, a pedestrian, or the like present around the vehicle including the vehicle control system 7000, for example.

The environmental sensor may be, for example, at least one of a rain sensor detecting rain, a fog sensor detecting fog, a sunlight sensor detecting sunlight intensity, or a snow sensor detecting snowfall. The surrounding information detecting sensor may be at least one of an ultrasonic sensor, a radar device, or a light detection and ranging, laser imaging detection and ranging (LIDAR) device. The imaging section 7410 and the outside-vehicle information detecting section 7420 may be each provided as an independent sensor or device, or may be provided as a device in which a plurality of sensors or devices is integrated.

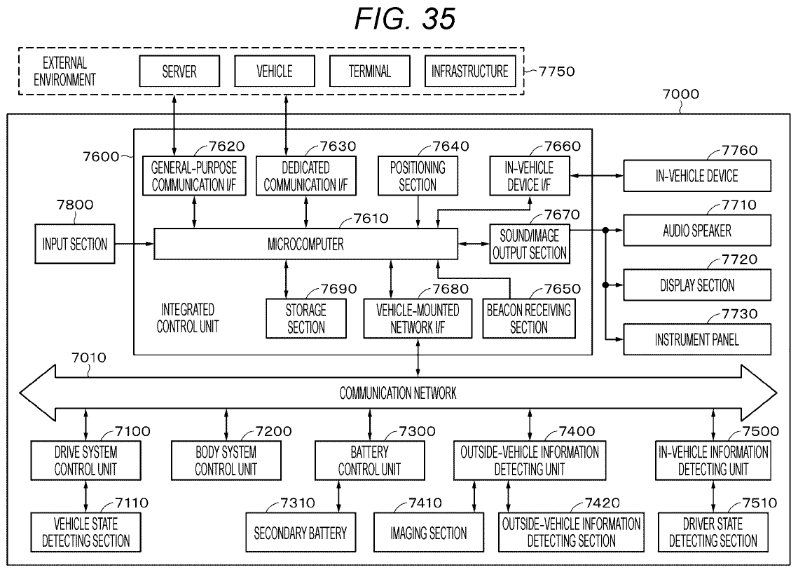

Here, FIG. 35 illustrates an example of installation positions of the imaging section 7410 and the outside-vehicle information detecting section 7420. Imaging sections 7910, 7912, 7914, 7916, and 7918 are, for example, provided at least one of positions on a front nose, sideview mirrors, a rear bumper, and a back door of a vehicle 7900 and an upper portion of a windshield within the interior of the vehicle. The imaging section 7910 provided on the front nose and the imaging section 7918 provided on the upper portion of the windshield within the interior of the vehicle capture mainly an image of the front of the vehicle 7900. The imaging sections 7912 and 7914 provided on the sideview mirrors capture mainly images of the sides of the vehicle 7900. The imaging section 7916 provided on the rear bumper or the back door captures mainly an image of the rear of the vehicle 7900. The imaging section 7918 provided on the upper portion of the windshield within the interior of the vehicle is used mainly to detect a preceding vehicle, a pedestrian, an obstacle, a traffic signal, a traffic sign, a lane, or the like.

Note that FIG. 35 illustrates an example of the imaging range of each of the imaging sections 7910, 7912, 7914, and 7916. An imaging range a indicates the imaging range of the imaging section 7910 provided on the front nose, imaging ranges b and c respectively indicates the imaging ranges of the imaging sections 7912 and 7914 provided on the sideview mirrors, and an imaging range d indicates the imaging range of the imaging section 7916 provided on the rear bumper or the back door. A bird's-eye image of the vehicle 7900 as viewed from above can be obtained by superimposing image data captured by the imaging sections 7910, 7912, 7914, and 7916, for example.

Outside-vehicle information detecting sections 7920, 7922, 7924, 7926, 7928, and 7930 provided on the front, rear, sides, and corners of the vehicle 7900 and the upper portion of the windshield within the interior of the vehicle may be, for example, an ultrasonic sensor or a radar device. The outside-vehicle information detecting sections 7920, 7926, and 7930 provided on the front nose, the rear bumper, and the back door of the vehicle 7900 and the upper portion of the windshield within the interior of the vehicle may be a LIDAR device, for example. These outside-vehicle information detecting sections 7920 to 7930 are used mainly to detect a preceding vehicle, a pedestrian, an obstacle, or the like.

Referring back to FIG. 34, the explanation continues. The outside-vehicle information detecting unit 7400 causes the imaging section 7410 to capture an image of the outside of the vehicle, and receives the captured image data. Furthermore, the outside-vehicle information detecting unit 7400 receives detection information from the outside-vehicle information detecting section 7420 connected to the outside-vehicle information detecting unit 7400. In a case where the outside-vehicle information detecting section 7420 is an ultrasonic sensor, a radar device, or a LIDAR device, the outside-vehicle information detecting unit 7400 causes the outside-vehicle information detecting section 7420 to emit an ultrasonic wave, an electromagnetic wave, or the like, and receives information regarding a received reflected wave. On the basis of the received information, the outside-vehicle information detecting unit 7400 may perform processing of detecting an object such as a human, a vehicle, an obstacle, a sign, a character on a road surface, or the like, or processing of detecting a distance thereto. The outside-vehicle information detecting unit 7400 may perform environment recognition processing of recognizing rainfall, fog, road surface conditions, or the like on the basis of the received information. The outside-vehicle information detecting unit 7400 may calculate a distance to an object outside the vehicle on the basis of the received information.

Furthermore, on the basis of the received image data, the outside-vehicle information detecting unit 7400 may perform image recognition processing of recognizing a human, a vehicle, an obstacle, a sign, a character on a road surface, or the like, or processing of detecting a distance thereto. The outside-vehicle information detecting unit 7400 may perform processing such as distortion correction or alignment on the received image data, and combine the image data captured by different imaging sections 7410 to generate a bird's-eye image or a panoramic image. The outside-vehicle information detecting unit 7400 may perform viewpoint conversion processing using the image data captured by the different imaging sections 7410.

The in-vehicle information detecting unit 7500 detects information about the inside of the vehicle. The in-vehicle information detecting unit 7500 is, for example, connected with a driver state detecting section 7510 that detects the state of a driver. The driver state detecting section 7510 may include a camera that captures an image of the driver, a vital sensor that detects vital information of the driver, a microphone that collects audio in the vehicle, and the like. The vital sensor is arranged on the seat surface, the steering wheel, or the like, and detects vital information of an occupant seated on the seat or the driver holding the steering wheel, for example. On the basis of detection information input from the driver state detecting section 7510, the in-vehicle information detecting unit 7500 may calculate a degree of fatigue of the driver or a degree of concentration of the driver, or may determine whether or not the driver is dozing. The in-vehicle information detecting unit 7500 may perform processing such as noise canceling processing on the collected audio signal.

The integrated control unit 7600 controls the overall operation within the vehicle control system 7000 in accordance with various programs. The integrated control unit 7600 is connected with an input section 7800. The input section 7800 is implemented by a device that can be operated by an occupant for input, such as a touch panel, a button, a microphone, a switch, or a lever. The integrated control unit 7600 may be supplied with data obtained by voice recognition of voice input through the microphone. The input section 7800 may, for example, be a remote control device using infrared rays or other radio waves, or an external connecting device such as a mobile phone or a personal digital assistant (PDA) compatible with the operation of the vehicle control system 7000. The input section 7800 may, for example, be a camera, and in that case, an occupant can input information by gesture. Alternatively, data obtained by detecting the movement of a wearable device worn by an occupant may be input. Moreover, the input section 7800 may, for example, include an input control circuit or the like that generates an input signal on the basis of information input by an occupant or the like using the above-described input section 7800 and outputs the generated input signal to the integrated control unit 7600. An occupant or the like inputs various kinds of data or gives an instruction for processing operation to the vehicle control system 7000 by operating the input section 7800.

The storage section 7690 may include a read only memory (ROM) that stores various programs to be executed by the microcomputer, and a random access memory (RAM) that stores various parameters, operation results, sensor values, and the like. Furthermore, the storage section 7690 may be implemented by a magnetic storage device such as a hard disc drive (HDD), a semiconductor storage device, an optical storage device, a magneto-optical storage device, or the like.

The general-purpose communication I/F 7620 is a general-purpose communication I/F that mediates communication with various devices present in an external environment 7750. The general-purpose communication I/F 7620 may implement a cellular communication protocol such as global system of mobile communications (GSM (registered trademark) ), worldwide interoperability for microwave access (WiMAX (registered trademark) ), long term evolution (LTE (registered trademark) ), or LTE-advanced (LTE-A), or another wireless communication protocol such as wireless LAN (also referred to as wireless fidelity (Wi-Fi (registered trademark) ) or Bluetooth (registered trademark). The general-purpose communication I/F 7620 may, for example, connect to a device (for example, an application server or a control server) present on an external network (for example, the Internet, a cloud network, or a carrier-specific network) via a base station or access point. Furthermore, the general-purpose communication I/F 7620 may connect to a terminal present in the vicinity of the vehicle (which terminal is, for example, a terminal of the driver, a pedestrian, or a store, or a machine type communication (MTC) terminal) using a peer to peer (P2P) technology, for example.

The dedicated communication I/F 7630 is a communication I/F that supports a communication protocol designed for use in vehicles. The dedicated communication I/F 7630 may implement a standard protocol such as wireless access in vehicle environment (WAVE), which is a combination of institute of electrical and electronic engineers (IEEE) 802.11p as a lower layer and IEEE 1609 as a higher layer, dedicated short range communications (DSRC), or a cellular communication protocol. The dedicated communication I/F 7630 typically carries out Vehicle to Everything (V2X) communication that is a concept including one or more of the following: Vehicle to Vehicle communication, Vehicle to Infrastructure communication, Vehicle to Home communication, and Vehicle to Pedestrian communication.

The positioning section 7640, for example, performs positioning by receiving a global navigation satellite system (GNSS) signal from a GNSS satellite (for example, a GPS signal from a global positioning system (GPS) satellite), and generates positional information including the latitude, longitude, and altitude of the vehicle. Note that the positioning section 7640 may identify a current position by exchanging signals with a wireless access point, or may obtain the positional information from a terminal such as a mobile phone, a personal handyphone system (PHS) handset, or a smart phone that has a positioning function.

The beacon receiving section 7650, for example, receives a radio wave or an electromagnetic wave transmitted from a radio station installed on a road or the like, and thereby obtains information about the current position, congestion, a closed road, a necessary time, or the like. Note that the function of the beacon receiving section 7650 may be included in the dedicated communication I/F 7630 described above.

The in-vehicle device I/F 7660 is a communication interface that mediates connection between the microcomputer 7610 and various in-vehicle devices 7760 present in the vehicle. The in-vehicle device I/F 7660 may establish wireless connection using a wireless communication protocol such as wireless LAN, Bluetooth (registered trademark), near field communication (NFC), or wireless universal serial bus (WUSB). Furthermore, the in-vehicle device I/F 7660 may establish wired connection such as universal serial bus (USB), high-definition multimedia interface (HDMI (registered trademark) ), or mobile high-definition link (MHL) via a connection terminal (and a cable if necessary) not illustrated in the drawings. The in-vehicle devices 7760 may, for example, include at least one of a mobile device or a wearable device possessed by an occupant or an information device carried into or attached to the vehicle.

Furthermore, the in-vehicle devices 7760 may also include a navigation device that searches for a route to any desired destination. The in-vehicle device I/F 7660 exchanges control signals or data signals with such in-vehicle devices 7760.

The vehicle-mounted network I/F 7680 is an interface that mediates communication between the microcomputer 7610 and the communication network 7010. The vehicle-mounted network I/F 7680 transmits and receives signals or the like in accordance with a predetermined protocol supported by the communication network 7010.

The microcomputer 7610 of the integrated control unit 7600 controls the vehicle control system 7000 in accordance with various programs on the basis of information obtained via at least one of the general-purpose communication I/F 7620, the dedicated communication I/F 7630, the positioning section 7640, the beacon receiving section 7650, the in-vehicle device I/F 7660, or the vehicle-mounted network I/F 7680. For example, the microcomputer 7610 may calculate a control target value for the driving force generating device, the steering mechanism, or the braking device on the basis of the obtained information about the inside and outside of the vehicle, and output a control command to the drive system control unit 7100. For example, the microcomputer 7610 may perform cooperative control intended to implement functions of an advanced driver assistance system (ADAS), the functions including collision avoidance or shock mitigation for the vehicle, follow-up driving based on a following distance, vehicle speed maintaining driving, a vehicle collision warning, a lane departure warning, and the like. Furthermore, the microcomputer 7610 may perform cooperative control intended for automated driving, which makes the vehicle travel automatedly without depending on the operation of the driver, or the like, by controlling the driving force generating device, the steering mechanism, the braking device, or the like on the basis of the obtained information about the surroundings of the vehicle.

The microcomputer 7610 may generate three-dimensional distance information between the vehicle and an object such as a surrounding structure, a person, or the like, and generate local map information including information about the surroundings of the current position of the vehicle, on the basis of information obtained via at least one of the general-purpose communication I/F 7620, the dedicated communication I/F 7630, the positioning section 7640, the beacon receiving section 7650, the in-vehicle device I/F 7660, or the vehicle-mounted network I/F 7680. Furthermore, the microcomputer 7610 may predict the risk of collision of the vehicle, approaching of a pedestrian or the like, an entry to a closed road, or the like on the basis of the obtained information, and generate a warning signal. The warning signal may, for example, be a signal for producing a warning sound or lighting a warning lamp.

The sound/image output section 7670 transmits an output signal of at least one of a sound or an image to an output device capable of visually or auditorily notifying an occupant of the vehicle or the outside of the vehicle of information. In the example in FIG. 34, an audio speaker 7710, a display section 7720, and an instrument panel 7730 are exemplified as the output device. The display section 7720 may, for example, include at least one of an on-board display or a head-up display. The display section 7720 may have an augmented reality (AR) display function. The output device may be other than these devices, and may be another device such as headphones, a wearable device such as an eyeglass type display worn by an occupant or the like, a projector, or a lamp. In a case where the output device is a display device, the display device visually displays results obtained by various kinds of processing performed by the microcomputer 7610 or information received from another control unit in various forms such as text, an image, a table, a graph, or the like. Furthermore, in a case where the output device is an audio output device, the audio output device converts an audio signal containing reproduced audio data or sound data or the like into an analog signal, and auditorily outputs the analog signal.

Note that, in the example illustrated in FIG. 34, at least two control units connected via the communication network 7010 may be integrated into one control unit. Alternatively, each individual control unit may include a plurality of control units. Moreover, the vehicle control system 7000 may include another control unit not illustrated in the drawing.

Furthermore, some or all of the functions performed by one of the control units in the above description may be assigned to another control unit. That is, predetermined calculation processing may be performed by any of the control units as long as information is transmitted and received via the communication network 7010. Similarly, a sensor or a device connected to any of the control units may be connected to another control unit, and a plurality of control units may mutually transmit and receive detection information via the communication network 7010.

In the vehicle control system 7000 described above, the lighting device of the present technology can be applied to the outside-vehicle information detecting section, for example.

### REFERENCE SIGNS LIST

10, 10A to 10T Lighting device
100 Ranging device
110 Light-emitting element
120 Light-emitting unit
150 Substrate
150A First main surface
150B Second main surface
311 First microlens array
312 Second microlens array
313 Collimator lens
314 Lens member
315, 321, 331, 350, 361 Diffusion plate
320 Rod lens array
340 Freeform lens
350 Metamaterial
360 Concave lens array
362 Diffraction grating

1. A lighting device comprising:
a light-emitting element including a plurality of light-emitting units arranged in an array;
a first optical member arranged near the light-emitting element, the first optical member being arranged in an emission direction of light beams emitted from the light-emitting units to reduce a gap between the light beams emitted from the light-emitting units adjacent to each other and make the light beams uniform in light intensity; and
a second optical member that roughly collimates divergent light from the first optical member.

2. The lighting device according to claim 1, wherein
the first optical member includes a first lens unit that causes the light beam emitted from each of the light-emitting units to converge, and a second lens unit that roughly collimates a divergent light beam after being converged by the first lens unit.

3. The lighting device according to claim 2, wherein
the first lens unit and the second lens unit are integrated into a single lens unit.

4. The lighting device according to claim 2, wherein
the light-emitting element includes a substrate, and
the plurality of light-emitting units is provided on a first main surface of the substrate, and the first lens unit is provided on a second main surface opposite to the first main surface.

5. The lighting device according to claim 1, wherein
the first optical member includes a rod lens array that makes the light beam emitted from each of the light-emitting units approximately uniform in light intensity.

6. The lighting device according to claim 1, wherein
the first optical member includes a diffraction grating that spreads the light beam emitted from each of the light-emitting units.

7. The lighting device according to claim 6, wherein
the diffraction grating splits the light beam emitted from a predetermined one of the light-emitting units into a predetermined number of regions, and light beams from the regions overlap at a position of an intermediate image.

8. The lighting device according to claim 6, wherein
the light-emitting element includes a substrate, and
the plurality of light-emitting units is provided on a first main surface of the substrate, and the diffraction grating is provided on a second main surface opposite to the first main surface.

9. The lighting device according to claim 1, wherein
the first optical member includes a freeform lens that spreads the light beam emitted from each of the light-emitting units.

10. The lighting device according to claim 9, wherein
the light-emitting element includes a substrate, and
the plurality of light-emitting units is provided on a first main surface of the substrate, and the freeform lens is provided on a second main surface opposite to the first main surface.

11. The lighting device according to claim 1, wherein
the first optical member includes a metamaterial that spreads the light beam emitted from each of the light-emitting units.

12. The lighting device according to claim 11, wherein
the light-emitting element includes a substrate, and
the plurality of light-emitting units is provided on a first main surface of the substrate, and the metamaterial is provided on a second main surface opposite to the first main surface.

13. The lighting device according to claim 1, wherein
a diffusion plate or a diffraction grating is arranged at a position of an intermediate image formed by the first optical member.

14. The lighting device according to claim 13, wherein
the first optical member includes a concave lens that spreads the light beam emitted from each of the light-emitting units, and
the diffusion plate is arranged between the concave lens and the second optical member.

15. The lighting device according to claim 14, wherein
the light-emitting element includes a substrate, and
the plurality of light-emitting units is provided on a first main surface of the substrate, and the concave lens is provided on a second main surface opposite to the first main surface.

16. The lighting device according to claim 1, wherein
each of the light-emitting units includes a surface-emitting laser.

17. The lighting device according to claim 1, wherein
the plurality of light-emitting units is capable of emitting light in a switchable manner for each light-emitting unit or for each group of light emitting units belonging to a predetermined region.

18. A lighting device comprising:
a light-emitting element including a plurality of light-emitting units arranged in an array; and
an optical functional member provided near the light-emitting element, the optical functional member being configured to make a light-emitting area larger for each of the light-emitting units and make a non-irradiation area between the light-emitting units smaller.

19. A ranging device comprising the lighting device according to claim 1.
